(19) United States
(12) Patent Application Publication
(10) Pub. No.: US 2025/0374008 A1
(43) Pub. Date: Dec. 4, 2025

(54) DIGITAL PASS SYSTEM AND METHOD

(71) Applicant: LOUIS LOMBARDI, QUAKERTOWN, PA (US)

(72) Inventor: LOUIS LOMBARDI, QUAKERTOWN, PA (US)

(73) Assignee: THE WALLET GROUP, GILBERTVILLE, PA (US)

(21) Appl. No.: 19/242,820

(22) Filed: Jun. 18, 2025

Related U.S. Application Data
(63) Continuation-in-part of application No. 17/866,524, filed on Jul. 17, 2022.

(51) Int. Cl. H04W 4/029; H04W 4/80

(52) U.S. Cl. CPC H04W 4/029; H04W 4/80

(57) ABSTRACT

Disclosed is a digital pass system that includes a network interface assembly including one or more computerized network devices. A promotional environment has at least one or more of spatial, temporal, material, and risk elements, the risk elements designed to calculate outcome probabilities. Included is at least one user interface wherein users may create through a digital pass portal at least one digital pass on at least one computerized device designed to accept receipt of at least one or more of information, coupons, and transactions via the network interface assembly. The network interface assembly is designed to send information to the at least one digital pass as prompted by a digital pass software based on at least one or more of the location of the at least one user, the time, the material associated with the information, and the probability the at least one user will respond positively.

### CLAIM OF PRIORITY

This application is a continuation-in-part of U.S. patent application Ser. No. 17/866,524, DIGITAL PASS SYSTEM AND METHOD, filed on Jul. 17, 2022, which is incorporated herein by reference in their entirety.

### FIELD OF THE INVENTION

The inventive concept relates generally to a digital pass system and method designed to allow people to receive electronic messages from product and service entities without requiring those people to provide private information.

### BACKGROUND

Obstacles exist that inhibit customers from adopting digital promotional systems. Chief among these obstacles are requirements to provide identity information which both takes time and reduces privacy. Mobile marketing technologies generally require users to provide personal information such as email and phone numbers, which users may prefer to keep confidential before application downloads are permitted. Required information creates friction and effort. Installations are required. Downloads are required. Information is required. Traditional applications require full installations to be added and typically require registrations that demand some type of identifying information. Cancelling a registration can also take burdensome effort for users and provide further friction, even for trials. Therefore, there is a need in the market for an improved way to promote digital information.

### SUMMARY OF THE INVENTION

Disclosed is a digital pass system and method designed to allow people via at least one computerized device to opt in to receive electronic messages, such as product promotions or information, without requiring people to submit or allowing access to their personal information.

One embodiment of the digital pass system includes a network interface assembly including one or more network devices. At least one control circuit assembly is designed to receive and transmit information via the network interface assembly. A promotional environment is designed to contain at least one user, the user detected from at least one mobile device, the promotional environment having at least one or more of a spatial element, a temporal element, a material element, and a risk element, the risk element designed to calculate outcome probabilities. At least one or more of an NFC tag, global positioning system GPS, Bluetooth beacon assembly, and a geofencing system is designed for determining a presence of the at least one user.

A user may be a recipient of a digital pass. A user may also be an issuer of a digital pass or a person working on behalf of an issuing entity.

The inventive concept includes at least one user interface wherein at least one user may create through a digital pass portal at least one digital pass on at least one computerized device designed to accept receipt of at least one or more of information, coupons, and transactions via the network interface assembly, the user interface disposed on at least one computerized device designed to receive a user component of the digital pass system by at least one or more of scanning and tapping an optical code, a computer link, text, email, and an NFC tag. The at least one mobile computerized device is designed to register at least one push notification service to provide a unique, secure, and randomized token into the digital pass wherein the digital pass software can determine if, when, and to whom to send information via the network interface assembly.

The network interface assembly is designed to send information to the at least one digital pass as prompted by the digital pass software based on at least one or more of a location of the at least one user, a time, a material associated with the information, and a probability the at least one user will respond to information positively, the probability further determined by at least one or more of past behavior statistics, and predictive algorithms, the predictive algorithms further designed to use data the user has permitted the digital pass software to receive. The at least one user initiates the receipt of at least one or more of information, coupons, and transactions by at least one or more of moving within the promotional environment and sending a request for a digital pass.

One embodiment of the digital pass system provides at least one user interface screen to allow the at least one user to select from at least one digital pass type from a plurality of possible types, choose from at least one action for the digital pass, configure the at least one digital pass, design the at least one digital pass, and activate the at least one digital pass, the at least one digital pass deployable by the one or more network devices.

One embodiment of the digital pass system provides at least one further user interface screen to allow the at least one user to sign up to receive credentials, log in to an associated dashboard, the dashboard designed to allow at least one or more of create a new digital pass, edit a digital pass, configure a digital pass, design a digital pass, deploy a digital pass, distribute a digital pass, use digital pass features, send messages to digital pass holders, track and measure digital pass campaigns, apply a code to a digital pass, send a bill, and pay a bill.

One embodiment of the digital pass system includes user vectors wherein the user vector of the at least one user are used to further determines if, when, to whom, and what information is sent.

One embodiment of the digital pass system maps pathways around obstacles within the spatial element of the promotional environment from which to calculate travel distances greater than direct distances.

One embodiment of the digital pass system provides at least one or more of a pass store wherein users can find, present, and transact digital passes, an ad network wherein users are presented with localized advertising, and a pass marketplace wherein users may find, present, and incorporate features into the digital pass.

One embodiment of the digital pass system includes a bidirectional capability wherein the at least one user can respond to information sent and an associated call to action.

One embodiment of the digital pass system includes at least one identifier for the at least one user from which the digital pass system is designed to collect data, the at least one identifier set apart from user-provided identity information.

Another embodiment the digital pass system includes a network interface assembly having one or more network devices and adapted for at least one promotion to iteratively determine presence and trajectory of at least one user and at least one second user within the promotional environment. At least one control circuit assembly is designed to receive and transmit information via the network interface assembly. The at least one user and at least one second user are each identified by unique serial numbers adapted to be separate from personally identifiable information, user data designed to be assigned to respective serial numbers incrementally from user inputs and user actions. The promotional environment spans within 10 to 3,280 feet from the center of the promotional environment. The at least one user and the at least one second user are considered members within the member set, the member set definable at selected points in time and able to be monitored by members therein with at least one or more of the global positioning system and the Bluetooth beacon assembly within 33 feet of given members, the at least one user and the at least one second user detectable from the at least one computerized device. Included is at least one user interface wherein the at least one user and the at least one second user may create through the digital pass portal at least one digital pass on the at least one computerized device, the at least one computerized device designed to accept receipt of at least one or more of information, coupons, and transactions via the network interface assembly, the user interface disposed on the at least one computerized device designed to receive the user component of the digital pass system by at least one or more of scanning and tapping the optical code, the computer link, text, email, and the NFC tag.

This embodiment of the digital pass system is designed to selectively provide at least one or more of the at least one user and the at least one second user the promotion from which to create the at least one digital pass based on the promotional score of at least one user and the at least one second user calculated from user data for each of the at least one user and the at least one second user, the user data including at least one or more of the spatial vector, the temporal vector, the material vector, and the risk vector, the promotional score designed to indicate the probability the at least one user and the at least one second user will act to create and use at least one digital pass based on vector similarities. The network interface assembly is designed to iteratively receive data that is at least one or more of tracked from the at least one user and the at least one second user and permitted by the at least one user and the at least one second user, the data which contributes to the user vector of each of the at least one user and the at least one second user wherein user data for the set members are compared with user data for at least one or more of past and present set members when determining promotional scores, wherein similarities and differences between user data and vectors for past and present set members are adapted, by way of at least one machine learning predictive algorithm, including decision trees and Bayesian networks, to predict whether the at least one user is the better candidate for receiving the promotion than the at least one second user, the data and vectors based on at least one or more of the location of the at least one user, the time, the material associated with the information, and the probability the at least one user will respond to information positively.

The inventive concept now will be described more fully hereinafter with reference to the accompanying drawings, which are intended to be read in conjunction with both this summary, the detailed description and any preferred and/or particular embodiments specifically discussed or otherwise disclosed. Inventive concepts may, however, be embodied in many different forms and should not be construed as limited to the embodiments set forth herein; rather, these embodiments are provided by way of illustration only and so that this disclosure will be thorough, complete, and will fully convey the full scope of the inventive concepts to those skilled in the art.

### BRIEF DESCRIPTION OF THE DRAWINGS

FIG. 1 illustrates one representative embodiment of the digital pass system;

FIG. 2 illustrates a digital pass portal and digital pass;

FIG. 3 illustrates a network interface assembly;

FIG. 4 illustrates the representative embodiment of the digital pass system within a geofencing system;

FIG. 5 illustrates a representative promotional environment as a mall installation of the digital pass system;

FIG. 6 illustrates scanning and tapping an optical code, a computer link, and an NFC tag;

FIGS. 7A-7D illustrates a representative method for using the digital pass system;

FIG. 8 illustrates another representative embodiment of the digital pass system within a geofencing system;

FIG. 9 illustrates a pass store, an ad network, and a pass marketplace;

FIGS. 10A-10J illustrate a representative set of screens for the user interface including, but not limited to, creating, selecting, configuring, designing, and deploying a digital pass;

FIGS. 11A-11H illustrate a representative set of screens for the network interface assembly including, but not limited to, message pass holders, administrate beacon and geo-fencing parameters, manage passholders and engagements, manage pass barcoding, and administer pass barcodes; and,

FIG. 12A-12I illustrate representative computer code for the digital pass system.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

Disclosed is a digital pass system and digital pass method designed to allow people via at least one computerized device to opt in to receive electronic messages, such as product promotions or information, without requiring people to submit or allowing access to their personal information. The digital pass system and method selects when to present messages based on at least one or more of: 1) spatial variables, such as the proximity of people to a promoting enterprise via Bluetooth and geofencing technologies; 2) temporal considerations, such as the optimal time window for a promotion; 3) material considerations, such as what products are to be promoted; and, 4) and risk considerations, such as considering the number of people within a spatial and temporal limit who would likely produce the intended result of a promotion without creating too much or too little demand. Material can be a tangible item such as a product and may also be an intangible item such as a service or a virtual item. The inventive concept may operate entirely in virtual space as represented by Facebook Meta or other virtual environments.

The digital pass system can be added to the mobile computerized device by such ways as electronic search and scanning optical codes such as QR codes, through hyperlinks, or by tapping an NFC tag. Through the digital pass system, the user permits the digital pass system to detect the user's presence by such ways, though not limited to, geofencing, Bluetooth beacon, or other signals from the at least one mobile computerized device the digital pass system further calculating velocity information as may be important to determine which message to send, for example, a welcome message if the user is approaching and a message designed to bring the user back of the user is departing. Geofencing in a virtual environment may be geofencing around a given virtual space such as a virtual store or virtual community.

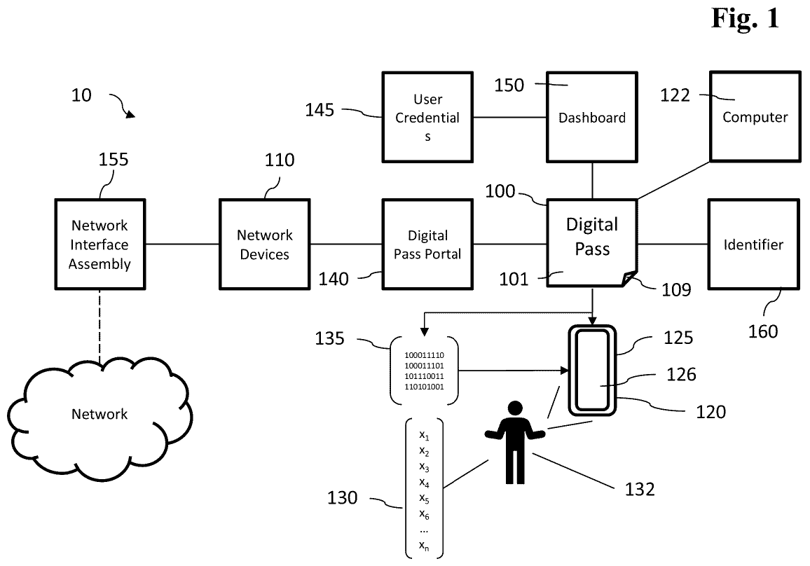

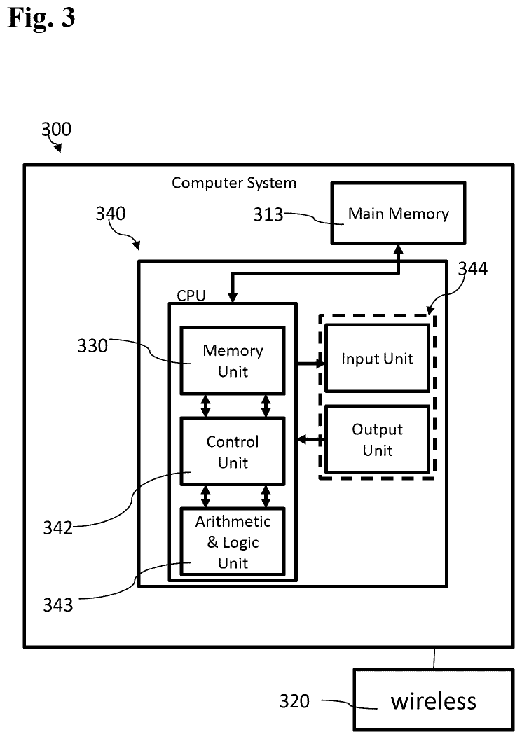

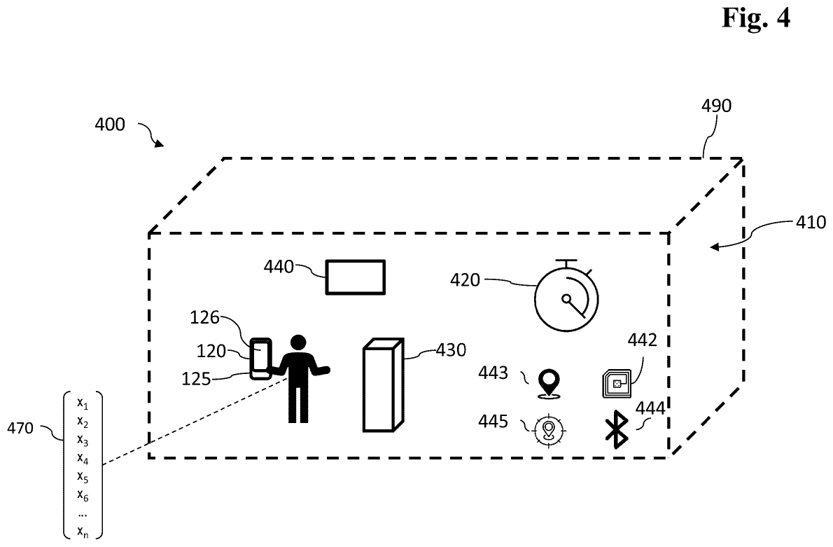

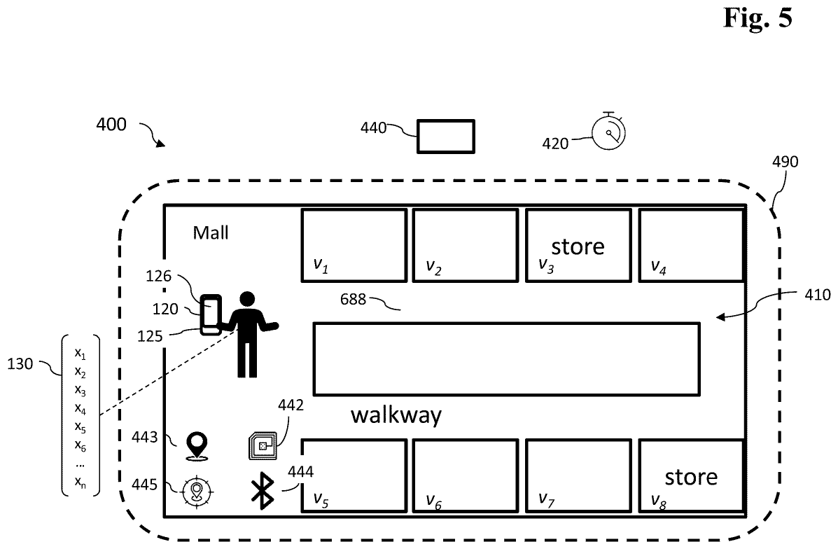

Referring to FIGS. 1-6, FIG. 1 illustrates one representative embodiment of the digital pass system 10 where a network interface assembly 155 includes one or more network devices 110. At least one control circuit assembly 340, as illustrated in FIG. 3, is designed to receive and transmit information via the network interface assembly 155. As illustrated in FIG. 4, a promotional environment 400 for the digital pass system 10 is designed to contain at least one user, the user detected from the user's at least one mobile computerized device 120. A mobile computerized device 120 is typically a smartphone but may also be such devices as a smartwatch, tablet, or a personal computer such as a laptop. The user is further able to retain personal identity information when interfacing with a given promotional environment 400 supported by a given digital pass system 10, promotional environments 400 having at least one or more of a spatial element 410, a temporal element 420, a material element 430, and a risk element 440, the risk element 440 designed to calculate outcome probabilities. Promotional environments 400, for illustration, could be a mall, as illustrated in FIG. 5, or a shopping district of a municipality where a cluster of stores may collectively create an attractive shopping area for customers while at the same time competing for attention for their store. To further illustrate, a restauranteur may use the disclosed inventive concept to encourage people to select their restaurant within a given promotional environment 400 when those people otherwise have many restaurants from which to choose. At least one or more of an NFC tag 442, global positioning system (GPS) 443, a Bluetooth beacon assembly 444, and a geofencing system 445 is designed for determining the presence of the at least one user. Users are individual people but also may be groups of people such as a family or members of an organization.

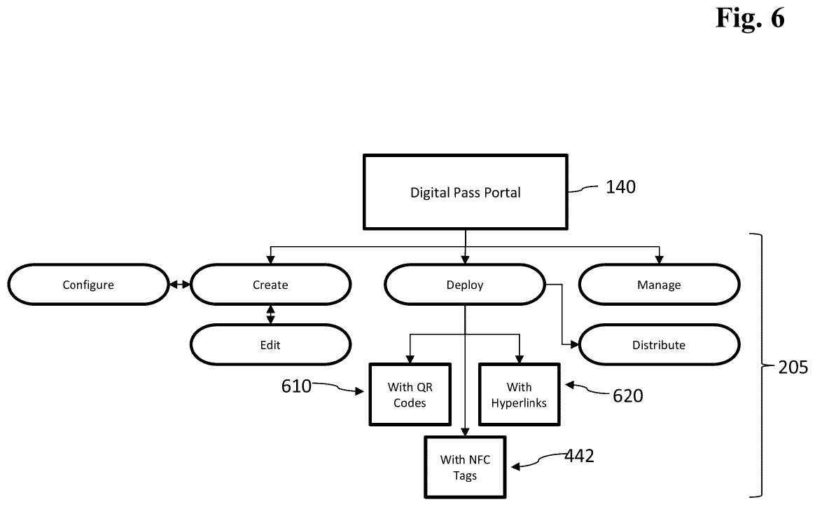

Included, as illustrated in FIG. 1, is at least one user interface 125 of the mobile computerized device 120 wherein the at least one user may create through a digital pass portal 140 at least one digital pass 100 on at least one computerized device 122 is designed to accept receipt of at least one or more of information, coupons, and transactions via the network interface assembly 155, the user interface 125 disposed on the at least one mobile computerized device 120 designed to receive user initiation by at least one or more of, as illustrated in FIG. 6, scanning and tapping an optical code 610, a computer link 620, and an NFC tag 442. Each digital pass 100 may have a front side 101 and a backside 109 that contains different information, coupons, and transactions. The at least one computerized device 122 may be the at least one mobile computerized device 120. In some embodiments, the at least one computerized device 122 may present a QR code that may be scanned from a screen of the given computerized device 122 by a given mobile computerized device 120.

The digital pass system 10 operates using characteristics of robotics excepting that it is the users who are tracked moving within the promotional environment 400. Robotic systems can be designed, as has the promotional environment 400, to integrate the OODA Loop (Observe, Orient, Decide, Act) to function effectively in dynamic environments. Observe: The digital pass system 10 uses real-time data about users in the promotional environment 400 through which users are tracked. Orient: This data is then processed to understand the context of their movement, which might involve machine learning algorithms interpreting movement information, assessing the current state of users, or recognizing patterns. Decide: Based on the orientation, which in this invention is to deliver a sweet spot number of promotions by way of a predictive algorithm designed to deliver no more and no fewer promotions than required to reach a selected promotional goal, the decision-making algorithms used for the digital pass system 10—which could be rule-based systems or more complex artificial intelligence (AI) using data and associated vectors 130 but does rely on decision trees and Bayesian networks—chooses the next action from a set of possible responses. This decision in robotics could range from navigating around an obstacle to interacting with an object or human, but in the promotional environment 400, where human users presumably could navigate around objects unaided, decisions are based on predicting actions and how promotions could influence those actions. Act: Finally, the promotions take the role actuators and motors designed to promote the sought action, which is where a difference from robotics happens because whether the sought action happens is based on probabilities where one aim of the invention is to continually improve predictive success. This loop continuously cycles, allowing the digital pass system 10 to adapt to new information or changes in its environment swiftly and proficiently.

For a representative illustration of how the invention predicts to whom to send digital passes 100, the invention iteratively collects data from users, each identified by a serial number designed to be apart from personal identifying information unless that given user opts to add personal identifying information. This data is collected into four categories with representative vector 130 variable examples illustrated, these which may further be developed for given promotional environments 400, enhanced by machine learning, and further divided into subcategories.

There is data with associated spatial vectors defined as: S=(s₁, s₂, . . . , sₙ) where sᵢ represents different spatial attributes (e.g., location, distance from a store, etc.)

There is data with associated temporal vectors defined T=(t₁, t₂, . . . , tₘ) where tⱼ represents different temporal attributes (e.g., time of day, day of week, seasonality, etc.) and where if viewed periodically or continuously can indicate change whereby location, above, can include present and predicted velocities and trajectories.

There is data with associated material vectors defined M=(m₁, m₂, . . . , mₖ) where mₗ represents different material or promotional content attributes of the coupon (e.g., discount percentage, type of product, design aesthetics, etc.)

There is data with associated risk vectors defined R where 0≤R≤1, representing the risk or likelihood of coupon non-use despite positive intent.

Given these, the predictive algorithm models an expected value E of a positive response to a coupon as a function: E=f(S, T, M, R) and explores conditional factors, for example, whether S|T>S|MT, where, for one example, the invention might predict whether it is more or less likely that a person in a mall will visit a given store if that person has just purchased coffee.

Assumed in this representative illustration is a a linear combination for simplicity, although in practice, particularly with the use of machine language algorithms, more complex logistic functions may be used that can handle non-linear interactions: E=α+β·S+γ·T+δ·M+ϵ·R+ζ·(S×T×M×R) Where: α is the baseline expected value when all other factors are at their base or zero level. β, γ, δ, ϵ are coefficient vectors or scalars corresponding to S, T, M, and R respectively, and indicate the weight or importance of each factor. ζ·(S×T×M×R) represents interaction terms, where ζ is a coefficient for this interaction, capturing how these factors might synergistically affect the outcome.

However, considering R is a probability, the invention is designed to incorporate R in a way that scales or tempers the influence of the other factors: E=(α+β·S+γ·T+δ·M)×(1−R). Here, (1−R) acts as a dampening factor: When R approaches 1 (high risk), E decreases because the positive impact of S, T, and M is reduced. When R is 0 (no risk), E is solely determined by the sum of the other components. For example, if a user identified with a serial numbers has consistently gone to one eatery during lunchtime, let's say for illustration 80% of the time, the risk R that even an otherwise perfectly matching promotion from another eatery would go unused would be considerably lower than if the promotion came from an eatery to which that user had never before gone. Such could account for brand affinities, as another illustration, and the predictive algorithm use R to account for such factors. It would not be, however, that the invention would necessarily ignore the lower probability user, given that winning a visit from that lower probability user could convert that user into a higher probability user, but that the calculations would consider the probabilities and risk R when determining the sweet spot number of promotions to send.

Where necessary, normalization or scaling functions ϕ takes place to ensure comparability: E=(α+β·ϕ(S)+γ·ϕ(T)+δ·ϕ(M))×(1−R), this involving scaling data so that it falls within a specific range, commonly [0, 1] or [−1, 1], to ensure that all features or inputs contribute equally to E. For illustration: ϕ(s₁) could be close to 1 for someone living very near the store and decrease as the distance increases. For a second illustration, ϕ(t₁) might peak around 3:00 p.m. and change towards midnight or noon, indicating less optimal times. For a third illustration, ϕ(m₁) might be 0.5 for a 50% discount, indicating the halfway mark in potential attractiveness or effectiveness of the coupon based solely on discount rate.

These normalized values then feed into the invention where:

$$E = ( α + β \cdot ϕ ( {s}_{1} ) + γ \cdot ϕ ( {t}_{1} ) + δ \cdot ϕ ( {m}_{1} ) ) \times ( 1 - R )$$

E is then transformable to P wherein:

$$P ( Positive Response ) = σ ( E ) = 1 / 1 + {e}^{- E}$$

where σ transforms E into a probability between 0 and 1.

While more than one computer algorithm may be used to achieve the predicted response, the algorithms are designed to follow the underlying logic illustrated here using S, T, M, and R vectors 130. The underlying mathematics may be discrete or continuous.

The invention is designed to use Bayesian models to improve predictions by incorporating prior knowledge and updating this knowledge with new data, for example prior knowledge about users and prior knowledge about users who may have similar vectors 130 to other users, where past behavior was recorded. As a representative embodiment based on the above, prior distributions can be to the parameters α, β, γ, δ, and perhaps to components of R where R does not have a fixed value. This prior information reflects initial suppositions about the parameters for providing digital passes 100 before observing the data. Using Bayes' theorem, therefore, the posterior distribution of the parameters given the data are computed, wherein:

$$P ( θ \vert data ) ∝ P ( data \vert θ ) \cdot P ( θ )$$

where, θ represents all parameters (α, β, γ, δ, and parameters of R).

As a representative illustration of decision trees, decision trees are used in the invention to predict the residuals (the differences between the observed responses to digital passes 100 and the predictions made by a given E. For example:

$$Compute residuals = {y}_{actual} - σ ( E ) .$$

Followed is training the decision tree on the residuals with illustrated inputs S, T, M, R, wherein new predictions result:

$${E}_{new} = σ ( E ) + DT ( S , T , M , R ) .$$

Decision trees are used as a part of the invention at least partly because they are adaptable to handling missing values to some extent and outliers in a way that linear models might not do so as well, important because the invention is designed to gather data iteratively. For example, the only data that the digital pass system 10 may have about a new user when the use opts in to the invention is that the user is in the promotional environment 400 at a certain place and time when that user receives a serial number. Where that user moves or is moving toward next may be the next incorporated data. A stop at a store or purchase may add more data, and so on, the amount of data that may be accumulated by the at least one user and at least one second user potentially different at a given point in time even by orders of magnitude. By incorporating decision trees, the invention improves predictions in scenarios where data might not be perfect and imperfectly aligned, accounting for also that vectors 130 may include null values in slots for given users because data that would be used in that slot sᵢ, tⱼ, mₗ, may yet be unknown, though it may be known in the future.

It should be understood that at least one user and at least one second user represents a set of users S for a given promotion. To illustrate this representatively, the invention defines universal sets and the subsets accordingly wish the given users for which it determines to whom to send a digital pass 100:
Universal Set=S. This set contains all users.
Set A is a subset of S containing at least one user.
Set B is another subset of S containing at least one different user or more, such that A and B are not necessarily disjoint but collectively cover S. Therefore:
   A⊆S: A is a subset of S, meaning all elements in A are also in S.
   B⊆S: B is also a subset of S, containing at least one different user than those in A or potentially overlapping with A in some elements but not completely identical to A.
   Let S be the universal set of all users.
      Now let A⊆S where A+Ø,
      Let B⊆S where B≠Ø, and
      A∪B=S, if S={u₁,u₂,u₃, . . . ,uₙ} where uᵢ represents individual users.

Now, let A={u₁}. Let B={u₂,u₃, . . . ,uₙ}. Here, A∪B=S because combining A and B gives back the entire set S, but the actual analysis may be involve one of the at least one second user, such as u₂, and A might be a plurality of at least one first user, such as u₁, and u₂ in a given analysis when A has more than one user. No individual, therefore, is exclusively in A or B as different analyses are made on S, and the invention will build sets A and B as required and draw individuals from those sets as required for the given analysis.

As noted, the above are not limited to be calculated by one particular computer language or another, but is designed to follow the flow using the illustrated mathematical backbone where if laid out in order, the invention has users with 1) serial numbers, 2) M, T, S as vectors 130, and 3) R, these being classic identifying categories associated with who, what, when where, with R covering the why and how, the latter which may be a probability where R=r and with r+(1−r)=1 incorporated into calculating E. The invention, for example, may predict a user identified by a given serial number has arrived in the promotional environment 400 at 7:30 am to go to Starbucks® for coffee because that user has done so almost every day that year, but there would still be some degree of uncertainty, and whether that user might go to another store afterward, especially if given a promotion, might have a wider variance than past behavior would help to calculate.

Further, the scope of S, T, M, and R may include absolute limits of a screening consideration, such as only including users within one hundred meters of given stores, or limits of a screening consideration may be allowed to vary. For example, the digital pass system 10 may select a user where the maximum acceptable distance away a given user could be to receive a given message correlates to the probability that the given user would act on the promotion. In this latter instance, therefore, the digital pass system 10 could allow the conditions where one user may receive a message pertinent to that user while another user closer to the promoted materials receives no message.

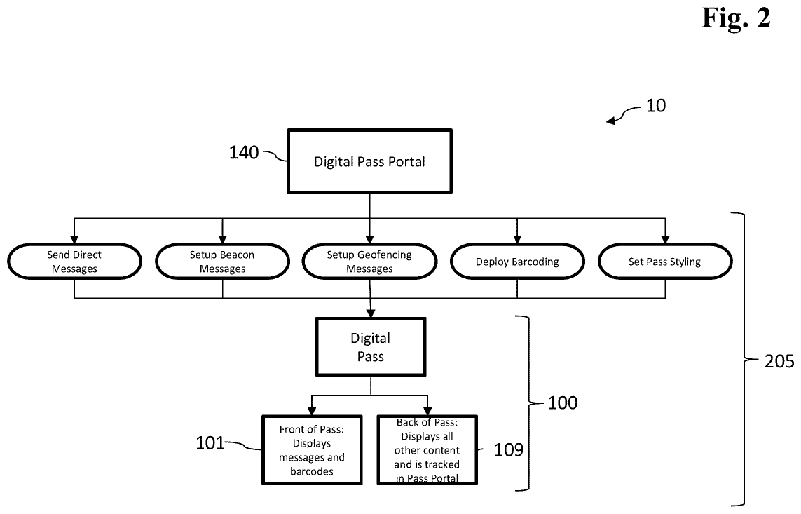

FIG. 1 further illustrates that the at least one mobile computerized device 120 is designed to register at least one push notification service to provide a unique, secure, and randomized token 135 into the digital pass 100 wherein, as illustrated in FIG. 2, digital pass software 205 can determining if, when, and to whom to send information via the network interface assembly 155. The network interface assembly 155 is designed to send information to the at least one digital pass 100 as prompted by the digital pass software 205 based on at least one or more of the location of the at least one user, the time, the material associated with the information, and the probability P the at least one user will respond to information positively, the probability further determined by at least one or more of past behavior statistics data and predictive algorithms, the predictive algorithms further designed to use data the user has permitted the digital pass software 205 to receive. The network interface assembly 155 may send information, coupons, and transaction substantially in real time though some delay may be permitted. The digital pass system 10 further tracks statistics of how many adds, how many messages were received by the consumer, and how much engagement transpired, to include, but not be limited by, phone calls, emails, texts, and link clicks.

The at least one user can initiate the receipt of at least one or more of information, coupons, and transactions by at least one or more of moving within the promotional environment 400 and sending a request for a digital pass 100. The boundaries of a given promotional environment 400 for a given user may be variable and may be predictive, for illustration, sending a digital pass 100 to a user outside the geo-fenced boundary 490 based on the probability the given user will enter a geo-fenced area instead of waiting until that given user enters the geo-fenced boundary 490. Such may not necessarily require that the user outside the geo-fenced boundary be tracked and could, for illustration, be time based, if there is a threshold probability that the user will enter the promotional environment 400 on a given day and time of the week because that has been the observed behavior pattern.

FIG. 1 further illustrates that in the representative embodiment, the digital pass system 10 further has at least one user interface screen 126 through which the at least one user selects from at least one type of digital pass 100, chooses from at least one action for the digital pass 100, configures the at least one digital pass 100, designs the at least one digital pass 100, and activates the at least one digital pass 100, the at least one digital pass 100 deployable by the one or more network devices 110.

FIG. 1. further illustrates that in the representative embodiment, the digital pass system 10 may include at least one interface screen 206 of the user interface 205 wherein the at least one user can sign up to receive credentials 145, log in to an associated dashboard 150, the dashboard 150 designed to allow at least one or more of creating a new digital pass 100, editing the digital pass 100, configuring the digital pass 100, deploying the digital pass 100, distributing the digital pass 100, using the features of the digital pass 100. People providing the at least one digital pass 100 can use the network interface assembly 155 leading to the digital portal 140 for sending messages to holders of digital passes, tracking and measuring digital pass campaigns, applying a code to the digital pass 100, sending a bill, and paying a bill.

FIG. 1 further illustrates that the representative embodiment of the digital pass system 10 include user vectors 130 wherein the user vectors 130 of the at least one user are used to further determine if, when, to whom, and what information is sent, these being the aforementioned S, T, M, and R. A user vector 130 is a representation of a user from which the digital pass system 10 can select actions to take based on how well the vector 130 matches given criterion. Ratings on a given criterion may be assigned as one or more variables to create the vector 130. The representative embodiment of the digital pass system 10 may further include within user vectors 130 directional information further mapped to pathways 688, as presented in a mall viewpoint of FIG. 6, which may include pathways 688 around obstacles within the spatial element 410 of the promotional environment 400 from which to calculate travel distances. As further illustration, the mall may further designate stores by node paths, the existence of paths literally and by probability, and their characteristics may be mapped such as the form G=(v₁, v₂, . . . , vₙ). Herein, machine learning may perform additional analysis, as patterns may develop useful for predicting. For illustration, if v₁ and v₂ sold complementary products, such as business clothes and fine shoes, a probable path between the two may be predicted for promotions; and if v₁ and v₂ were two competing outlets, such as two coffee shops, a probable path between the two once a user has visited and purchased from one may be predicted to not exist for that user, at least on that prediction time period. Nodes may be between stores or enterprises, within enterprises, involving other elements of a promotional environment 400, as aids in establishing predictive patterns.

When comparing combined vector 130 variables representing users for similarity, the invention uses several mathematical methods. Among these is cosine similarity, which measures the cosine of the angle between two vectors 130. Given the at least one user, User1 with vector \vec{U}₁1=(S₁,T₁,M₁,R₁) and the at least one second user, User2 with vector \vec{U}₂=(S₂,T₂,M₂,R₂), here illustrated with one individual each for clarity:

$$Similarity = cos ( θ ) = {\vec{U}}_{1} \cdot {\vec{U}}_{2} / ‖ {\vec{U}}_{1} ‖ ‖ {\vec{U}}_{2} ‖$$

Where: \vec{U}₁·\vec{U}₂ is the dot product of \vec{U}₁ and \vec{U}₂ where ∥\vec{U}₁∥ and ∥\vec{U}₂∥ are the magnitudes (Euclidean norms) of the vectors 130. An at least one user and an at least one second user that have, in this analysis, a small angle formed by vectors 130 joined at their bases would be more alike than if their two vectors 130 formed a larger angle.

Further applied is Euclidean Distance, which measures the straight-line distance between two points in Euclidean space. Lower distance indicates higher similarity.

$$d ( {\vec{U}}_{1} , {\vec{U}}_{2} ) = {( {( {S}_{1} - {S}_{2} )}^{2} + {( {T}_{1} - {T}_{2} )}^{2} + {( {M}_{1} - {M}_{2} )}^{2} + {( {R}_{1} - {R}_{2} )}^{2} )}^{1 / 2}$$

Similarity between users is be inversely related to distance.

If certain dimensions (such as S or R) are more important than other, the invention may ascribe weights to vectors 130 and their components. For illustration:

$${Similarity}_{w} = {\sum }_{i} {w}_{i} ( {U}_{1 i} \cdot {U}_{2 i} ) {( {\sum }_{i} {w}_{i} {U}_{1 i 2} \cdot {\sum }_{i} {w}_{i} {U}_{2 i 2} )}^{- 1 / 2}$$

Where wᵢ are weights for each component.

Typically, before applying these measures, vector 130 components are normalized or standardized to prevent dimensions with larger scales from dominating the similarity calculation. If dealing with high-dimensional data, dimension reduction may be performed by way of such techniques such as PCA or t-SNE. PCA is a linear dimensionality reduction method that identifies principal components to capture variance in high-dimensional data, and t-SNE is a non-linear technique that models high-dimensional data by preserving local distances in a lower-dimensional space, focusing on visualizing clusters or patterns. Hybrid approaches might be useful where different similarity measures are used for different parts of the vectors 130 (e.g., cosine for S, Euclidean for T, etc.), and then these are combined into an overall similarity score. By these, the intent is to get good enough results in real time through estimates when perfect information calculations are not required for invention prediction success.

Regarding iterative data collection of individual users, machine learning is further adapted to develop and improve algorithms based on prior probabilities where prior data is data it did not have before. This basic equation, therefore, is:

$$P ( A \vert {DX}_{1} … {X}_{n} )$$

where machine learning is adapted to explore whether or not a prediction for A is conditional from D, X, or other given variables which can denote a discrete or continuous numerical value or may denote a binary value of present or absent, has occurred or has not occurred.

FIG. 4 illustrates that the representative embodiment of the digital pass system 10 may further include at least one or more of NFC tags 442, GPS 443, a Bluetooth beacon assembly 444, and a geofencing system 445, each designed for determining the location of the at least one user. One representative embodiment of the digital pass system 10 supports locational messages that work from 10 feet to 3,280 feet. One representative embodiment of the digital pass system 10 supports beacon messages that work from 0.25 feet to 35 feet. Other embodiments may have different ranges. In some embodiments of the digital pass system 10 support unlimited geo locations which may be located outside supported stores within the represented ranges.

FIG. 1 further illustrates that the representative embodiment of the digital pass system 10 may further include a bidirectional capability wherein the at least one user can respond to information sent and an associated call to action from that information. The representative embodiment of the digital pass system 10 may further include at least one identifier 160 for the at least one user from which the digital pass system 10 is designed to collect data, the at least one identifier 160 set apart from user-provided identity information.

FIG. 2 illustrates the digital pass software 205 and representative actions that can be taken wherein the digital pass 100 is created through the digital portal 140. The digital pass software 205 is not limited to the representative actions, and these are illustrations of one representative embodiment of the digital pass system 10.

FIG. 3 illustrates the at least one computer system 300 designed to receive and transmit information via the network interface assembly 320. FIG. 3 further illustrates an at least one control circuit assembly 340 wherein the control circuit assembly 340 comprises a volatile memory storing a set of one or more computer-readable interactions executable by the control circuit assembly 340. Further included are at least one input and output units 344, main memory 313, memory units 330, control units 342, and arithmetic and logic units 343 as required for digital pass system 10 operations.

FIGS. 1 and 3, illustrate that the network interface assembly 155 may have one or more network devices 110 configured to allow the control circuit assembly 340 to receive and transmit information via a wireless network interface assembly 320. In some embodiments, the network interface assembly 155 may have one or more of a network modem, a router, data port, and transceiver assembly. The wireless network interface assembly 320 may have the network interface assembly 155 configured to allow the exchange of data. In some embodiments, the network interface assembly 320 may have one or more of the Internet, a local area network, a private network, a virtual private network, a home network, a wired network, and the wireless network interface assembly 320.

FIG. 5 illustrates a representative mall installation as a promotional environment 400 which, in this representative illustration, is encompassed by the geofencing system 445, and also illustrates NFC tags 442, global positioning system 443, a Bluetooth beacon assembly 444. The representative promotional environment 400 has at least one or more of the spatial element 410, the temporal element 420, the material element 430, and the risk element 440, the risk element designed to calculate outcome probabilities.

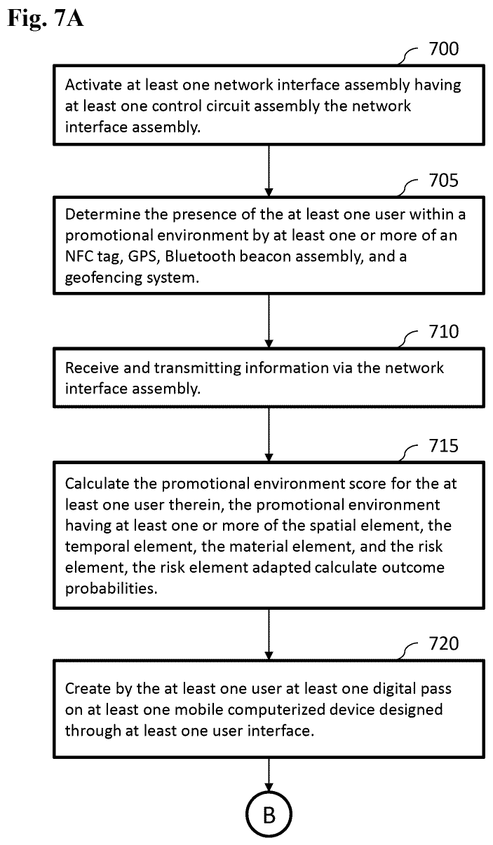

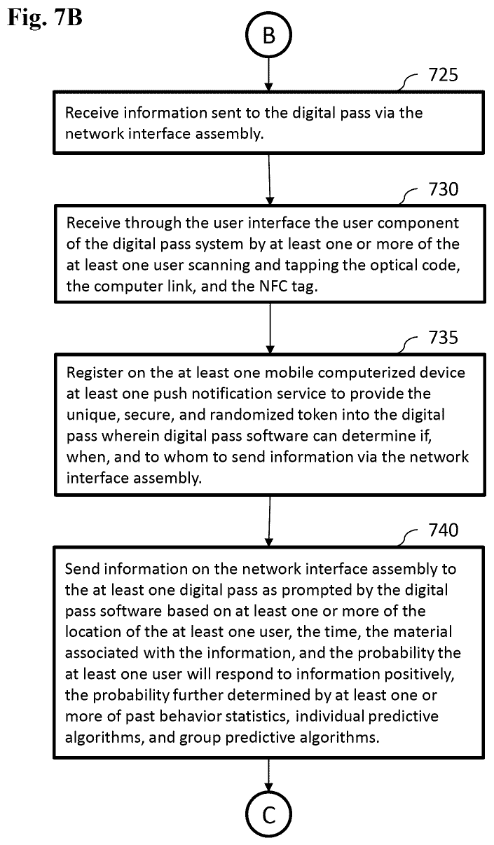

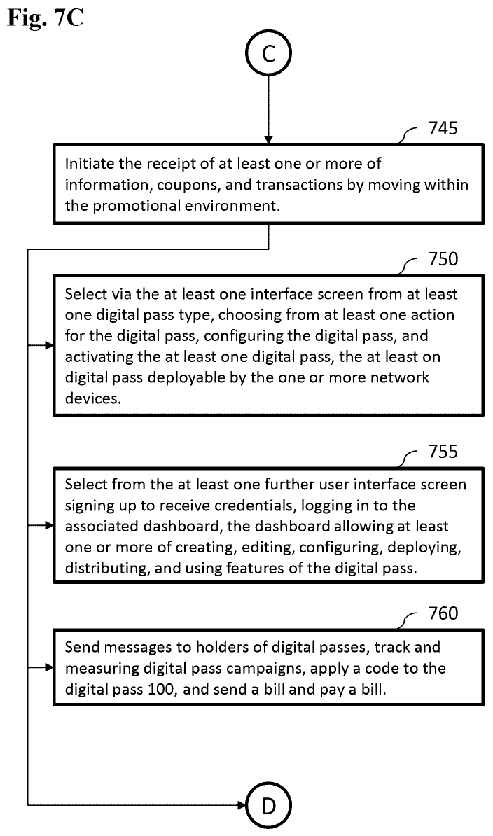

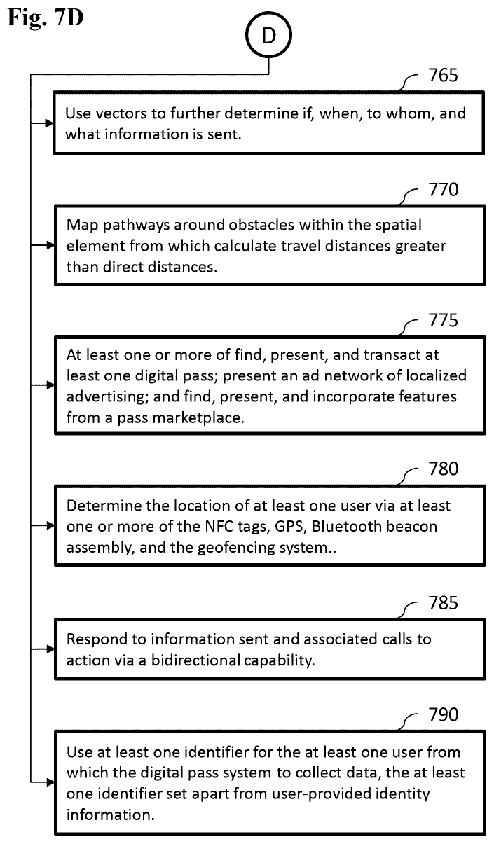

FIGS. 7A-7D illustrate a representative method for using the digital pass system 10, the method including the step of 700, activating at least one network interface assembly 155 having at least one control circuit assembly 340 for the network interface assembly 155. The method further includes the step of 705 determining the presence of the at least one user within a promotional environment 400 by at least one or more of an NFC tag 442, global positioning system 443, Bluetooth beacon assembly 444, and a geofencing system 445.

The method further includes the step of 710, receiving and transmitting information via the network interface assembly 155. The method further includes the step of 715 calculating a score for the given promotional environment 400 for the at least one user therein, which in the representative environment creates the at least one vector 130, the promotional environment 400 having at least one or more of the spatial element 410, the temporal element 420, the material element 430, and the risk element 440, the risk element designed to calculate outcome probabilities.

FIGS. 7A-7D illustrate that the representative method for using the digital pass system 10 further includes the step of 720, creating through the digital pass portal 140 by the at least one user at least one digital pass 100 on at least one mobile computerized device 120 designed through at least one user interface 125. The method further includes the step of 725, receiving information sent to the digital pass 100 via the network interface assembly. The method further includes the step of 730 the user interface 125 receiving the user component of the digital pass software 205 by at least one or more of the at least one user scanning and tapping the optical code 610, the computer link 620, and the NFC tag 442. The method further includes the step of 735 registering on the at least one mobile computerized device 120 at least one push notification service to provide the unique, secure, and randomized token 135 into the digital pass 100 wherein digital pass software 205 can determine if, when, and to whom to send information via the network interface assembly 155.

FIGS. 7A-7D further illustrate that the representative method for using the digital pass system 10 includes the step of 740, sending information on the network interface assembly to the at least one digital pass 100 as prompted by the digital pass software 205 based on at least one or more of the location of the at least one user, the time, the material associated with the information, and the probability the at least one user will respond to information positively, the probability further determined by at least one or more of past behavior statistics, individual predictive algorithms, and group predictive algorithms. The method further includes the step of 745, the at least one user initiating the receipt of at least one or more of information, coupons, and transactions by moving within the promotional environment 400.

FIGS. 7A-7D further illustrate that the representative method may further include the step of 750, at least one user selecting via the at least one user interface 125 from at least one digital pass 100 type, choosing from at least one action for the digital pass 100, configuring the digital pass 100, and activating the at least one digital pass 100, the at least one digital pass 100 deployable by the one or more network devices 110.

FIGS. 7A-7D illustrate that the representative method may further include the step of 755 the at least one user selecting from the at least one further user interface screen 126 signing up to receive credentials 145, logging in to the associated dashboard 150, the dashboard 150 allowing at least one or more of creating, editing, configuring, deploying, distributing, and using features of the digital pass 10. FIGS. 7A-7D illustrate that the representative method may further include the step of 760, sending messages to holders of digital passes, tracking and measuring digital pass 100 campaigns, applying a code to the digital pass 100, and sending a bill and paying a bill.

FIGS. 7A-7D illustrate that the representative method may further include the step of 765, using vectors 130 to further determine if, when, to whom and what information is send.

FIGS. 7A-7D illustrate that the representative method may further include the step of 770, mapping pathways around obstacles within the spatial element 410 from which to calculate travel distances greater than direct distances.

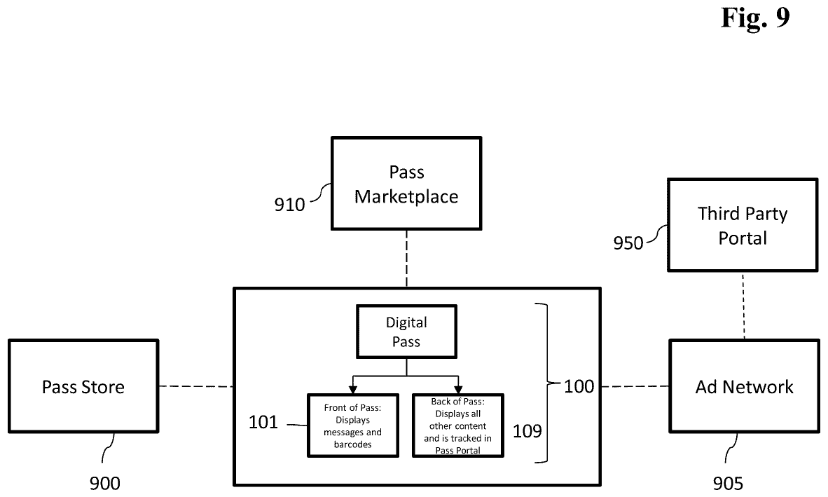

FIGS. 7A-7D further illustrate that the representative method may further include the step of 775 at least one or more of finding, presenting, and transacting from, as illustrated in FIG. 9, at least one pass store 900 at least one digital pass 100, presenting an ad network localized advertising from an ad network 905, and finding, presenting, and incorporating features from a pass marketplace 910.

FIGS. 7A-7D further illustrate that the representative method may further include the step of 780, determining the location of at least one user via at least one or more of the NFC tags 442, global positioning system 443, Bluetooth beacon assembly 444, and the geofencing system 445.

FIGS. 7A-7D illustrate that the representative method may further include the step of 785, responding to information sent and associated calls to action via a bidirectional capability.

FIGS. 7A-7D illustrate that the representative method may further include the step of 790, using at least one identifier 160 for the at least one user from which the digital pass system 10 to collect data, the at least one identifier 160 set apart from user-provided identity information.

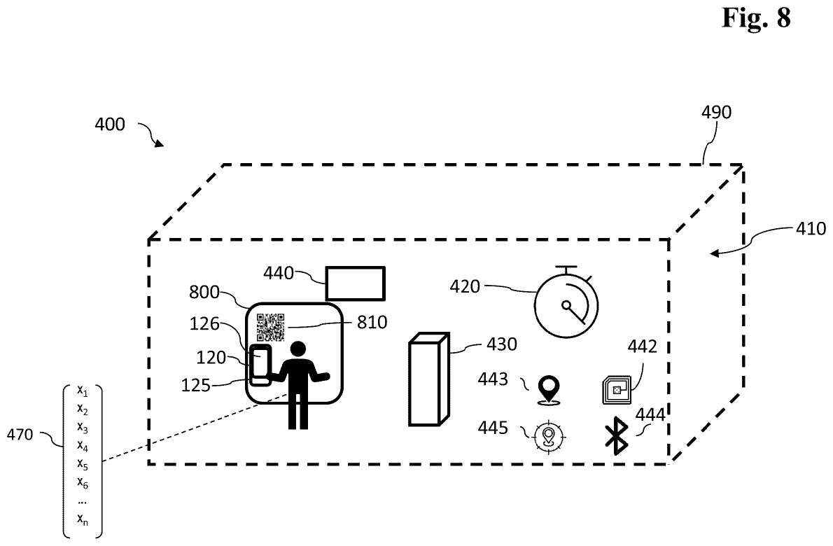

FIG. 8 illustrates that another representative embodiment of the digital pass system 10 includes the network interface assembly 155 having the one or more network devices 110, the at least one control circuit assembly 340 designed to receive and transmit information via the network interface assembly 155. A promotional interface 800 is designed to communicate with at least one user, the user initiating the communication from at least one mobile computerized device 120, the user further able to retain personal identity information when interfacing the promotional interface. This representative embodiment includes the at least one user interface 125 wherein the at least one user may create with the digital pass portal 140 the at least one digital pass 100 on the at least one computerized device 122 designed to accept receipt of at least one or more of information, coupons, and transactions via the network interface assembly, the user interface 125 disposed on the at least one mobile computerized device 120 designed to receive the user component of the digital pass system 10 by at least one or more of scanning and tapping the optical code 610, the computer link 620, and the NFC tag 442.

The at least one mobile computerized device 120 is designed to register the at least one push notification service to provide the unique, secure, and randomized token 135 into the digital pass 100 wherein digital pass software 205 can determining if, when, and to whom to send information via the network interface assembly 155. The network interface assembly 155 sending information to the at least one digital pass 100 as prompted by the digital pass software 205 based on at least one or more of the location of the at least one user, the time, the material associated with the information, and the probability the at least one user will respond to information positively, the probability further determined by at least one or more of past behavior statistics and predictive algorithms, the predictive algorithms further designed to use data the user has permitted the digital pass software 205 to receive. The at least one user initiating the receipt of at least one or more of information, coupons, and transactions by the at least one or more of interfacing with the promotional interface 800 and sending the request for the digital pass 100.

FIG. 8 further illustrates that in this representative embodiment of the digital pass system 10, the promotional interface 800 operates within the promotional environment 400 having at least one or more of the spatial element 410, the temporal element 420, the material element 430, and the risk element 440, the risk element designed to calculate outcome probabilities. In this representative embodiment of the digital pass system 10, the user may interface with at least one QR code 810.

In this representative embodiment of the digital pass system 10, at least one identifier 160 for the at least one user from which the digital pass system 10 is designed to collect data, the at least one identifier 160 set apart from user-provided identity information. In some embodiments, the user may, at the user's discretion, provide identity information. Identity information, in such embodiments, is stored in a secure data pass and allows the digital pass 100 to become a unique asset per user, depending on how the digital pass 100 has been configured.

Once a given digital pass 100 is added to a given user's mobile computerized device 120, in some embodiments within a digital wallet, the digital pass 100 can be the automatic information system based on 1) the spatial context of that user and 2) as the user engages with locations issuers may have set up. The given user does not have to do anything more than move around and new experiences can emerge automatically using that digital pass 100. Spatial examples include but are not limited to: 1) NFC tags 442, which enable notifications when tapping the tag with the user's mobile computerized device about 0-2 inches from at least one portion of the network interface assembly; 2) Bluetooth beacons 444, which enable notifications within approaching within about 1-33 feet of at least one portion of the network interface assembly; and 3) Geofencing addresses 443, which enabling notifications within about 34 feet-3280 feet from at least one portion of the network interface assembly. How engagement takes place includes receiving information, seeking information, gaining perspective on from information, making decisions from information, taking actions on information, and assessing results of information use.

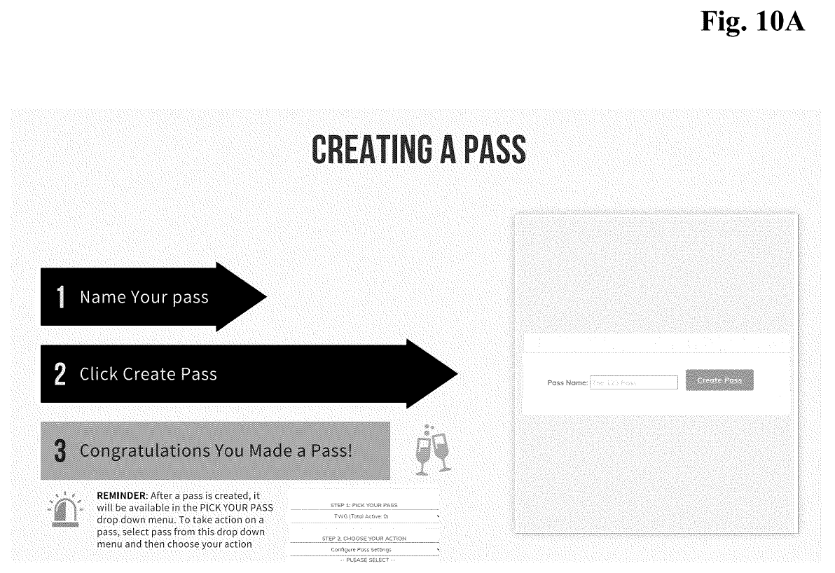

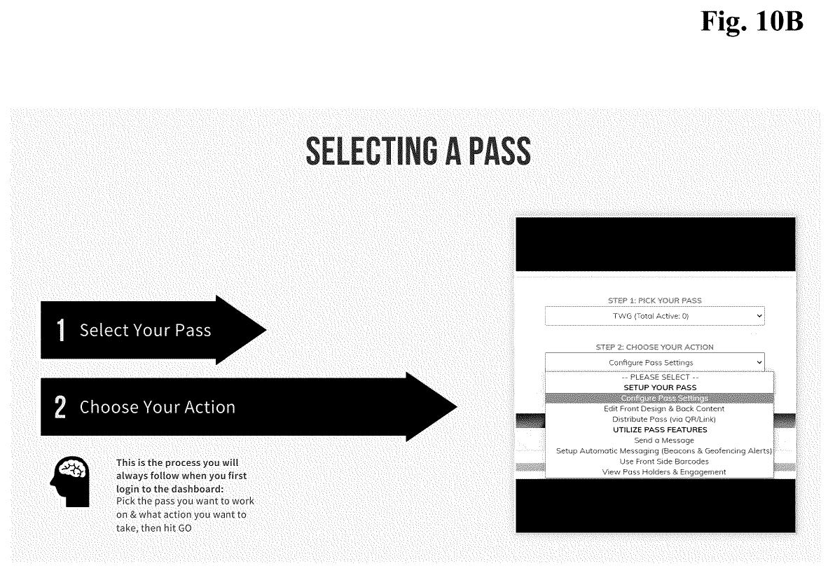

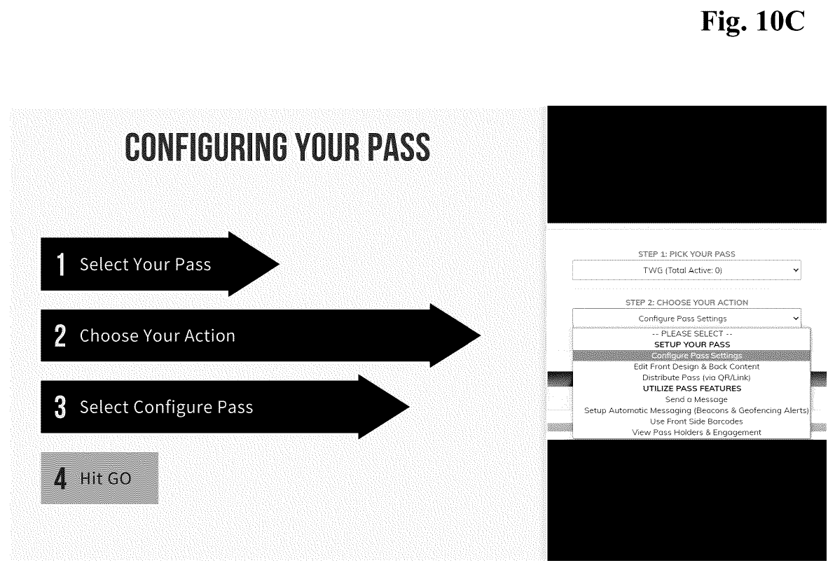

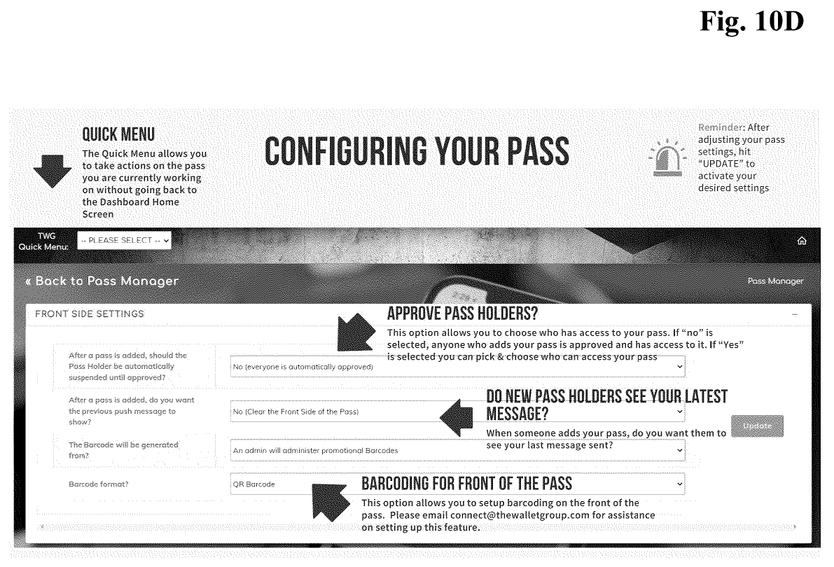

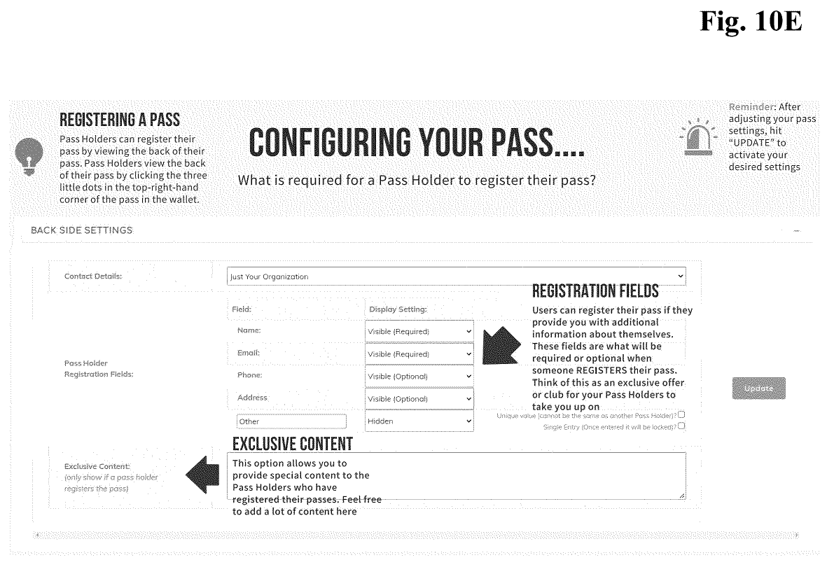

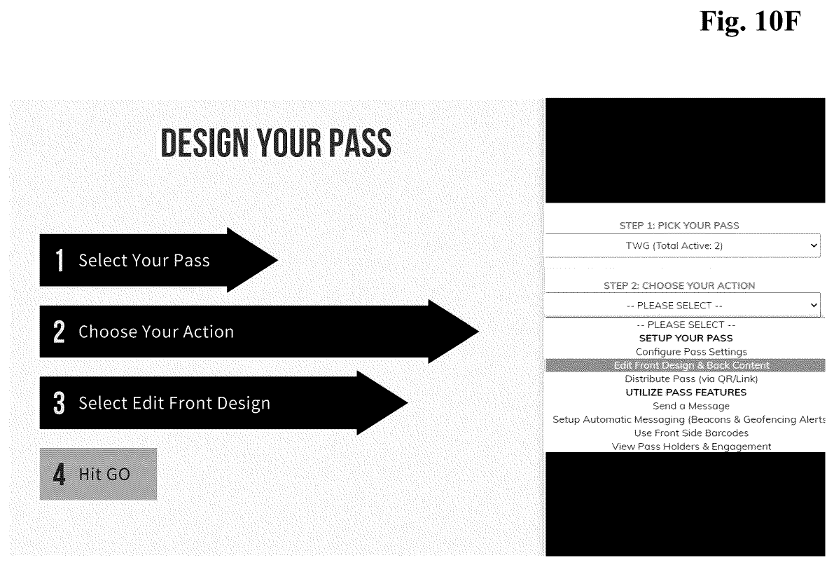

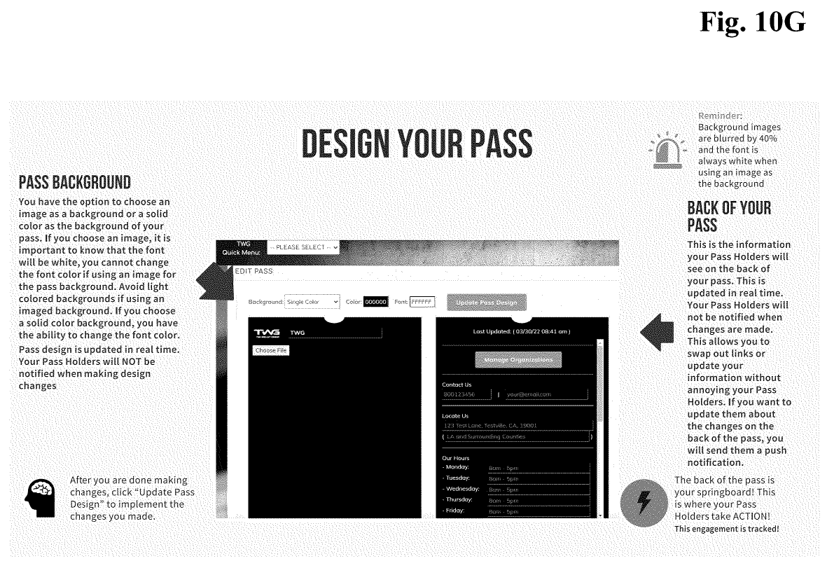

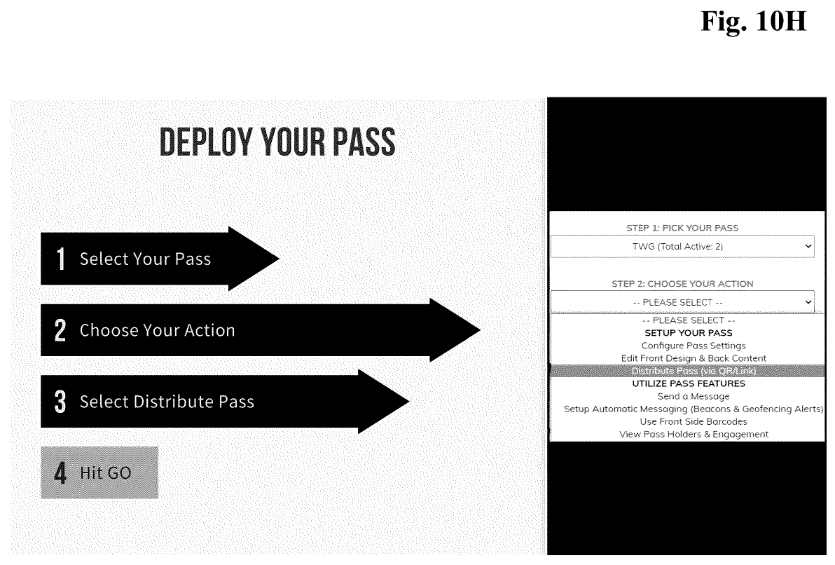

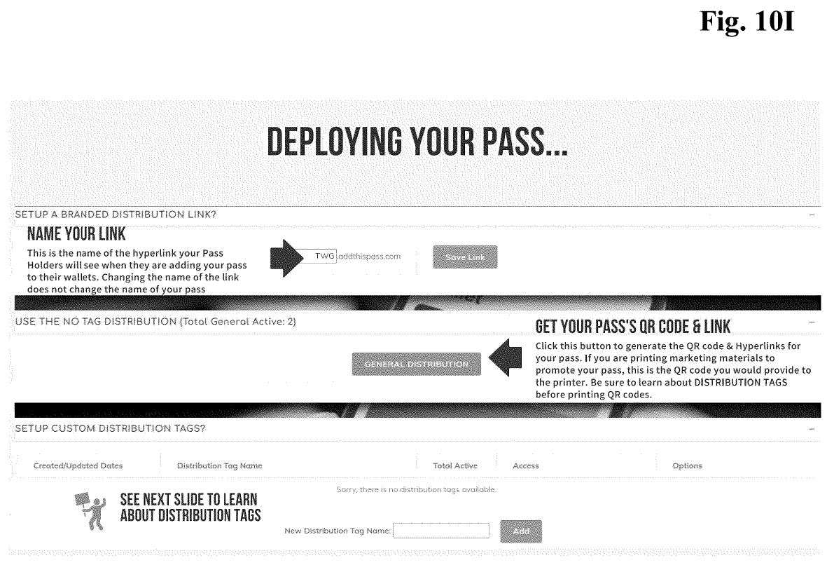

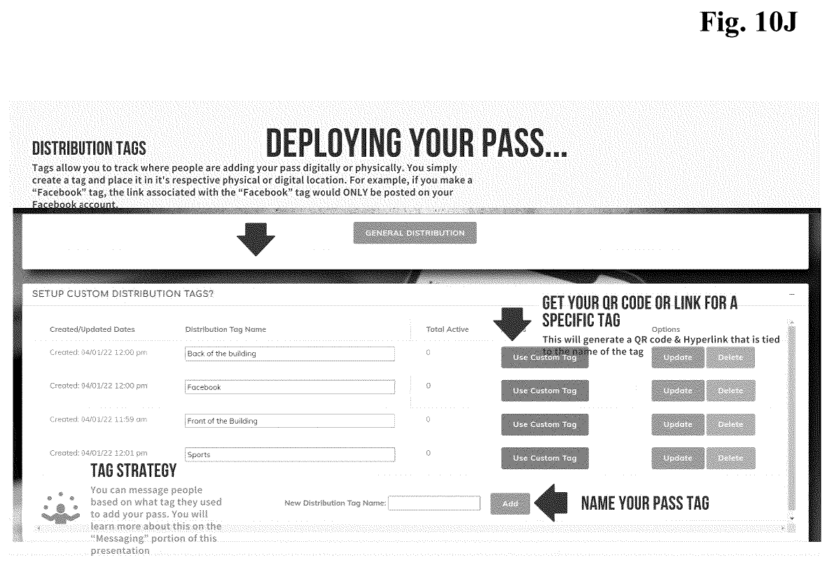

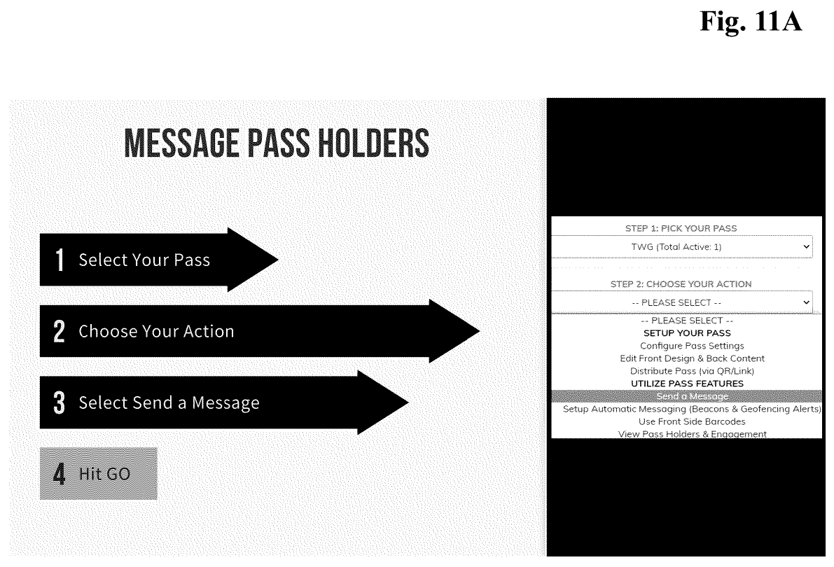

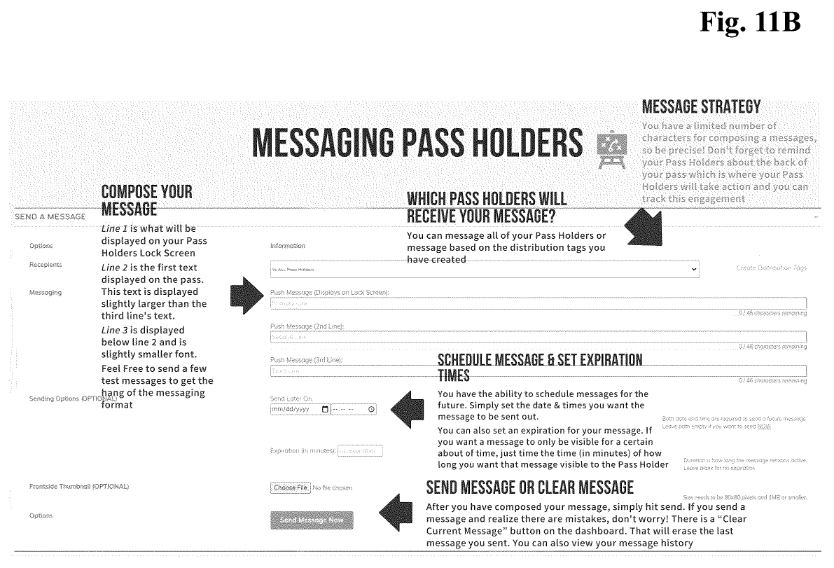

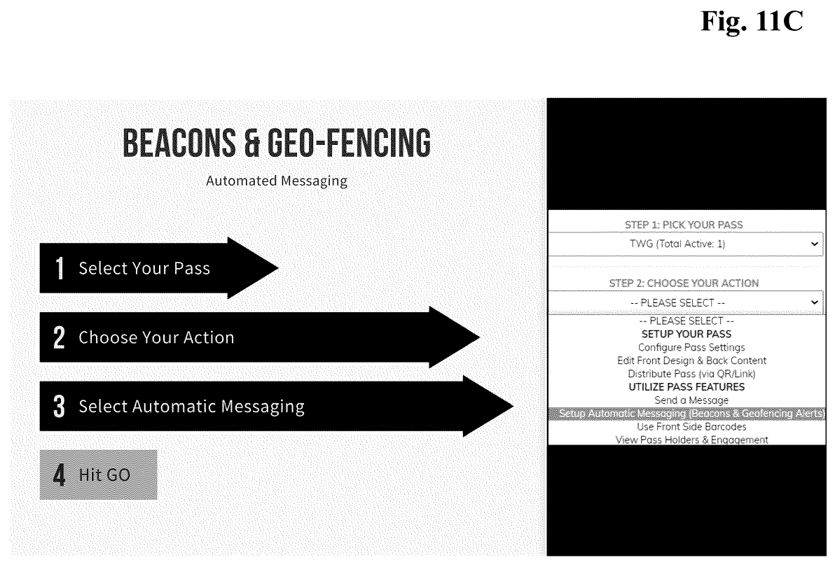

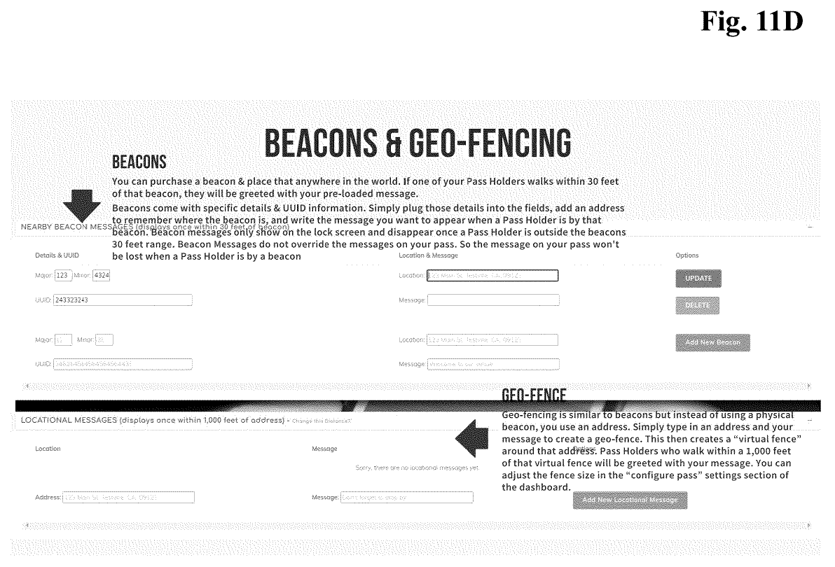

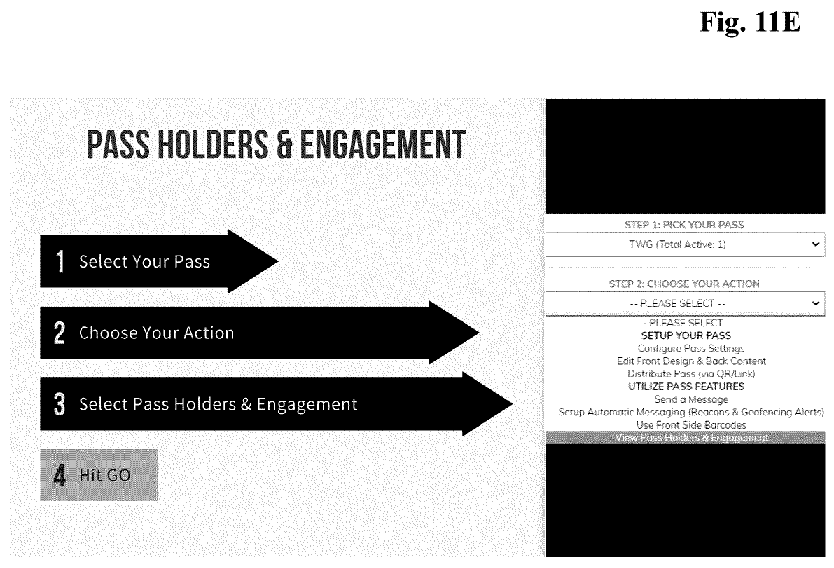

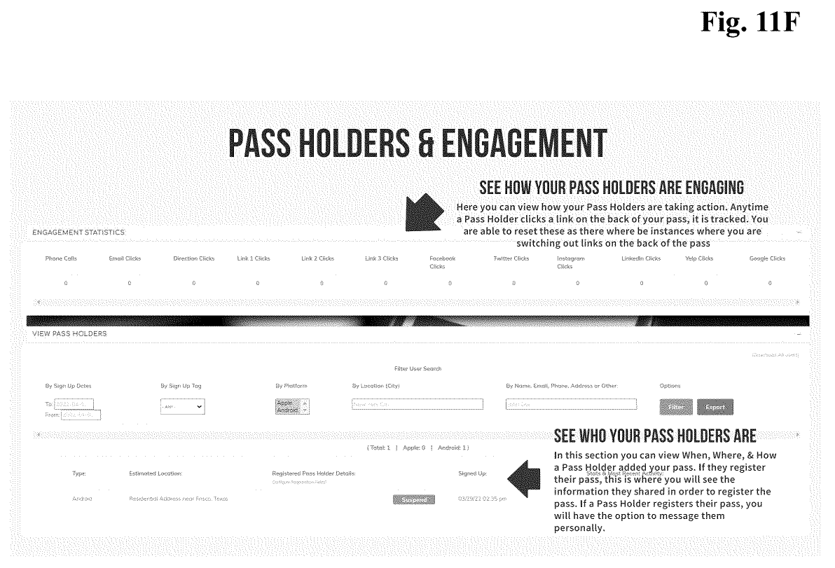

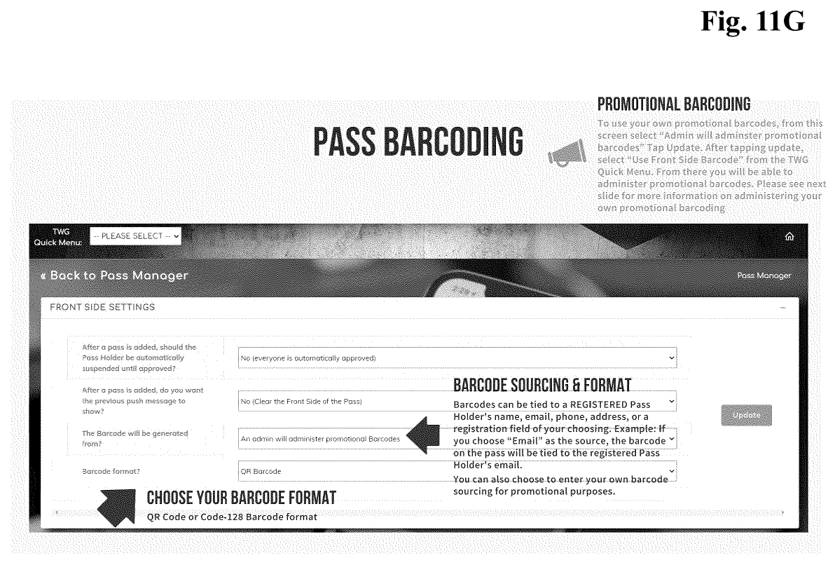

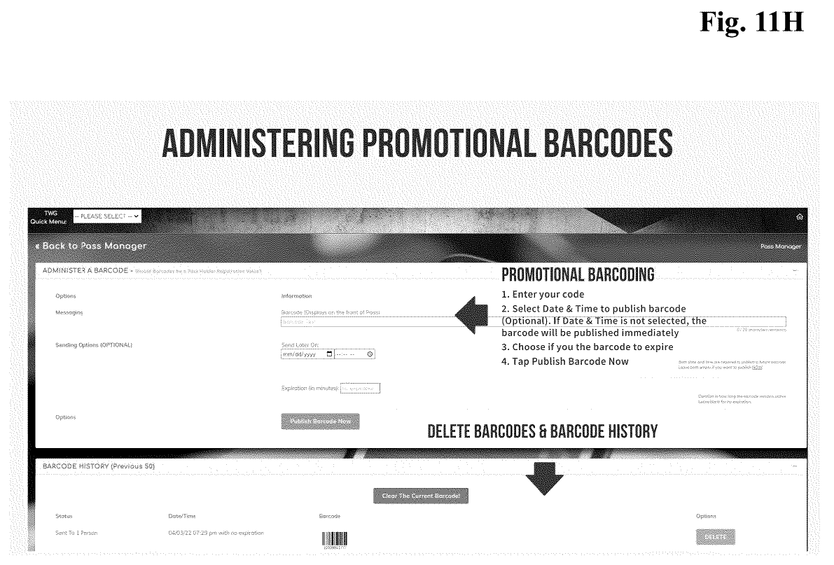

In representative embodiments of the digital pass system 10, the digital pass 100 can be registered. In this embodiment, the at least one user registers the given digital pass 100 by accessing the backside of the digital pass 109, as illustrated in FIG. 2, and clicking “Register this digital pass”. The creator of the digital pass 100 determines what information is required to register the digital pass 100. In exemplary embodiments, the digital pass creator can require name, email, address to register the digital pass 100. The issuer of the digital pass 100 can also request whatever additional information from the at least one user if the at least one user wants to register. A front of the digital pass 101 may display such information as messages and barcodes Registration is an exchange of information between the given holder (user) of the digital pass 100 and the organization (creator) of the digital pass 100 for exclusivity, validation, and/or promotional purposes. The given user of the digital pass 100 typically gives information in exchange for something. Representative screen shots appear in FIGS. 10A-10J, and FIGS. 11A-11H.

In one representative embodiments of the digital pass system 10, the criterion for issuing and redeeming the digital pass 100 can change depending upon whether previous results are greater or lesser than forecasted to raise or lower the likelihood of further action taken on the give digital pass 100. For one representative illustration, if the seats at a venue that are accessible via the digital pass 100 are not being filled, additional messages can be sent to users presenting a better offer. If the seats are filled, messages can be erased from form the at least one user's digital pass 100, assuring that no one can take up the offer after quantities have been filled.

In representative embodiments of the digital pass assembly 10, the at least one user can observe another holder of the digital pass 100 using the promotion that was delivered to the digital pass 100 and be reminded to use the promotion on the digital pass 100. Also, if the issuer of the digital pass 100 is changed, the notifications relative to the capacity of the offer (10 seats left, 9 now left, etc.), then users redeeming offers potentially create the scarcity situation driving competition for the redemption before the offer expires or is termed.

Representative embodiments of the digital pass system 10 have engagement tracking. The digital pass system 10 knows how many users received notifications or engage with offer links or phone numbers. Historical data can be reviewed to determine the success of information and promotion. The digital pass system 10 can further compute the total number of people to which an offer was sent to that of redemption to determine return on investment (ROI). The digital pass system 10 can further be used in simulations for predictive modeling on significant ROI notification offers.

FIG. 9 illustrates that one representative embodiment of the digital pass system provides at least one or more of a pass store 900, wherein users can find, present, and transact digital passes, an ad network 905 wherein users are presented with localized advertising, and a pass marketplace 910 wherein users may find, present, and incorporate features into the digital pass 10. The pass store 900 is substantially an app store wherein people can search for specific categories and brands of digital passes 100 and offer types and be shown relative digital passes 100 that would be appropriate to add to their digital wallet. The ad network 905 holds one digital passes 100 that could reveal localized and relevant ads. For illustration, if a user adds the user's child's high school to the user's digital wallet, the back side of the digital pass 109 might have an ad present for a local pizza shop next to the school that offers 50% off to all students with a clickable link. A third-party portal 950 may be present for third party advertisers such as the representative pizza shop that can identify the type of consumer they are looking for and pay to have their advertisement served up into digital passes 10 for those appropriate consumers.

The back of any digital pass 109 may contain brand information and may also serve as a springboard for user engagement. Issuers can look up a feature they want to add to their given digital pass 100, for illustration, a loyalty program. Users can search for this or any other features introduced to the pass marketplace 910 and activate the feature as a paid subscription in their digital pass 100. Representative categories include, but are not limited to, loyalty, rewards, and commerce, and the issuer, typically a brand, can choose which of these modules to activate depending on their use and how robust they want their digital pass 100 to be.

FIGS. 10A-10J illustrate a representative set of screens for the user interface 125 including, but not limited to, creating, selecting, configuring, designing, and deploying a digital pass 100.

FIGS. 11A-11H illustrate a representative set of screens for the network interface assembly 155 including, but not limited to, message pass holder, administrate beacon and geo-fencing parameters, manage passholders and engagements, manage pass barcoding, and administer pass barcodes.

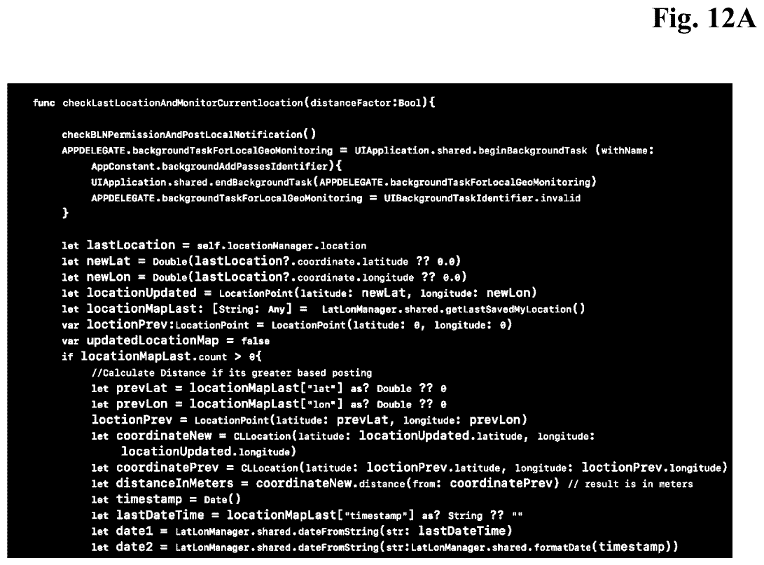

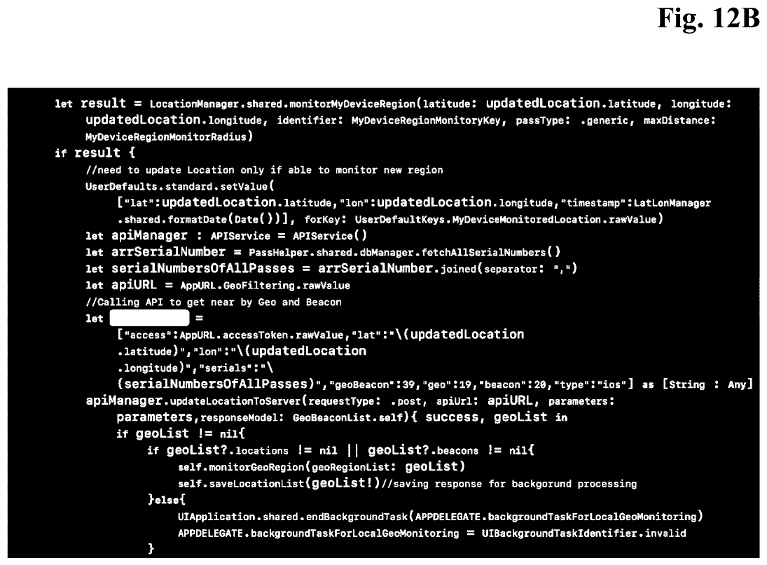

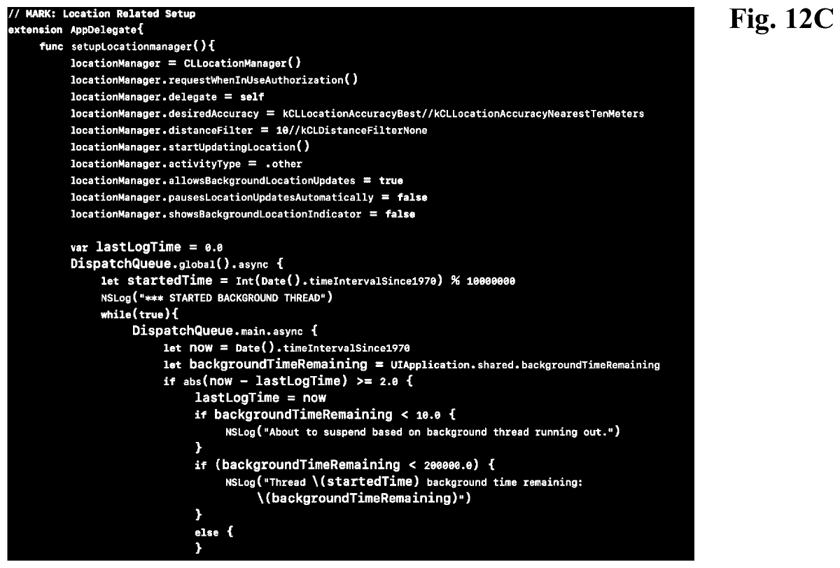

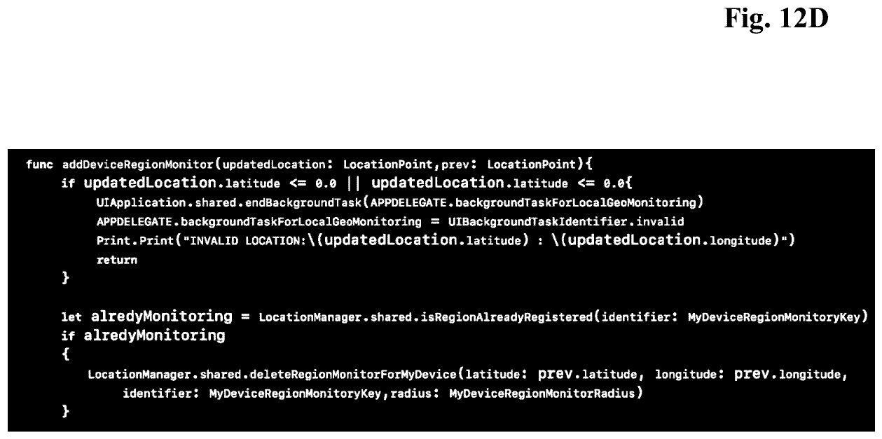

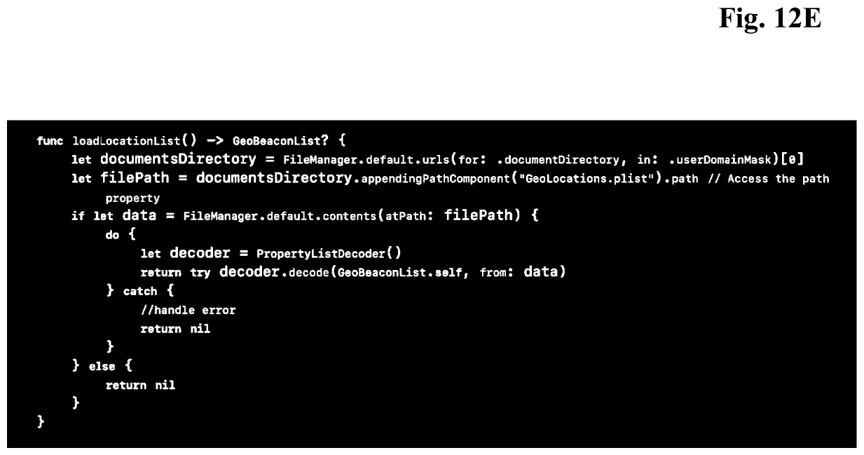

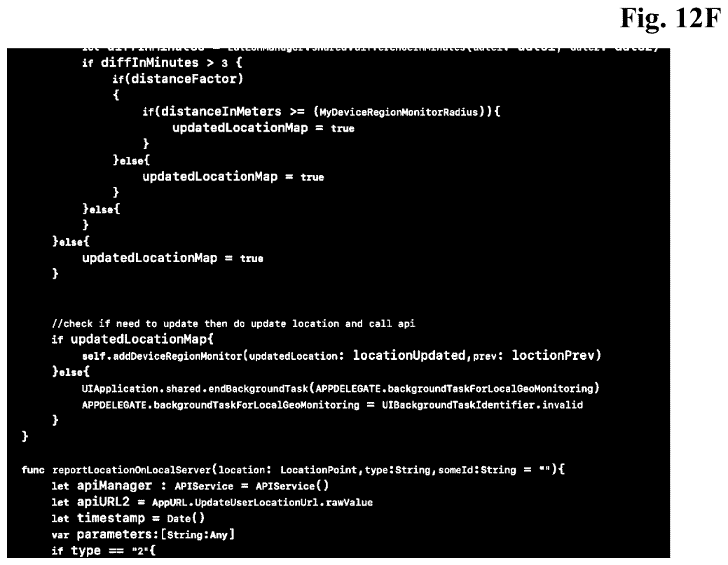

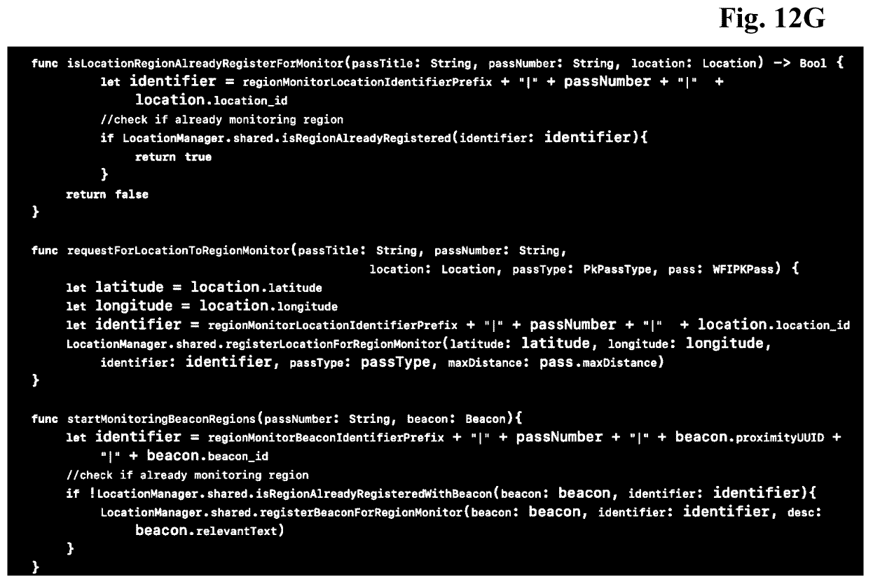

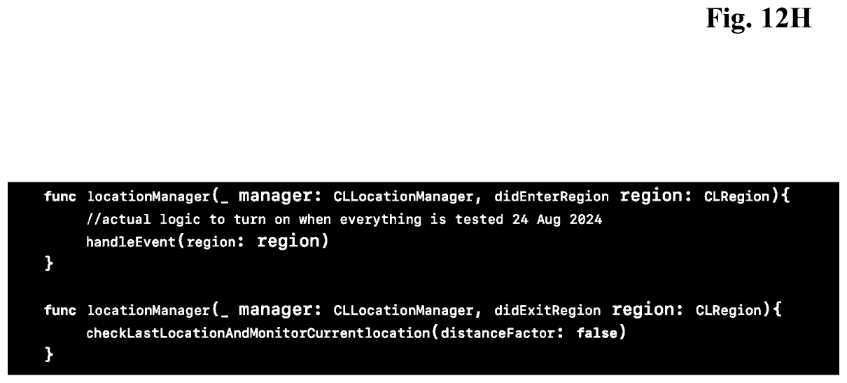

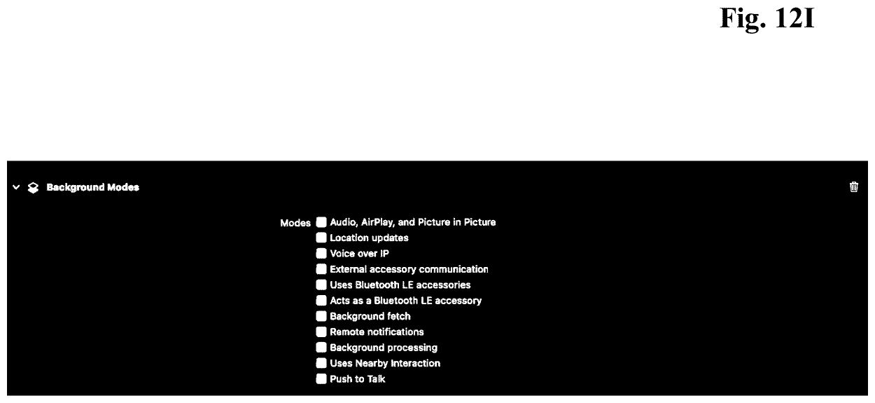

FIGS. 12A-12I illustrate representative computer code used within representative embodiments of the digital pass system 10. Other software code may be used from other software languages. The code is designed for general operations and to produce practical results from the representative mathematical algorithms applied by this invention to deliver digital passes 100.

The following patents are incorporated by reference in their entireties: U.S. Pat. Nos. 4,103,807B2, 4,282,849B2, 4,684,047B2, 4,705,015B2, 5,038,987B2, 5,165,584B2, 5,243,957B2, 5,243,959B2, 5,246,154B2, 5,497,512, 6,591,825B2, 6,948,690B2, 7,290,689B2, 7,527,182B2, 7,798,137B2, 8,161,956B2, 8,336,746B2, 8,814,018B2, 8,899,217B2, 11,009,308B2, US20120043362A1, and US20220082350A1.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

1. A digital pass system comprising:
a network interface assembly having one or more network devices and adapted for at least one promotion to iteratively determine presence and trajectory of at least one user and at least one second user within a promotional environment;
at least one control circuit assembly adapted to receive and transmit information via the network interface assembly;
the at least one user and at least one second user each identified by unique serial numbers adapted to be separate from personally identifiable information, user data adapted to be assigned to respective serial numbers incrementally from user inputs and user actions;
the promotional environment spanning within 10 to 3,280 feet from a center of the promotional environment, the at least one user and the at least one second user considered members within a member set, the member set definable at selected points in time and able to be monitored by members therein with at least one or more of a global positioning system and a Bluetooth beacon assembly within 33 feet of given members, the at least one user and the at least one second user detectable from an at least one computerized device;
at least one user interface wherein the at least one user and the at least one second user may create through a digital pass portal at least one digital pass on the at least one computerized device, the at least one computerized device adapted to accept receipt of at least one or more of information, coupons, and transactions via the network interface assembly, the user interface disposed on the at least one computerized device adapted to receive a user component of the digital pass system by at least one or more of scanning and tapping an optical code, a computer link, text, email, and an NFC tag;
wherein the digital pass system is adapted to selectively provide at least one or more of the at least one user and the at least one second user a promotion from which to create the at least one digital pass based on a promotional score of at least one user and the at least one second user calculated from user data for each of the at least one user and the at least one second user, the user data including at least one or more of a spatial vector, a temporal vector, a material vector, and a risk vector, the promotional score adapted to indicate a probability the at least one user and the at least one second user will act to create and use at least one digital pass based on vector similarities; and
the network interface assembly adapted to iteratively receive data that is at least one or more of tracked from the at least one user and the at least one second user and permitted by the at least one user and the at least one second user, the data which contributes to the user vector of each of the at least one user and the at least one second user wherein user data for the set members are compared with user data for at least one or more of past and present set members when determining promotional scores, wherein similarities and differences between user data and vectors for past and present set members are adapted, by way of at least one machine learning predictive algorithm including decision trees and Bayesian networks to predict whether the at least one user is a better candidate for receiving a promotion than the at least one second user, the data and vectors based on at least one or more of the location of the at least one user, the time, the material associated with the information, and the probability the at least one user will respond to information positively.

2. The digital pass system of claim 1 further comprising at least one user interface screen through which at least one or more of the at least one user and the at least one second user selects from at least one digital pass type, chooses from at least one action for the digital pass, configures the at least one digital pass, designs the at least one digital pass, and activates the at least one digital pass, the at least one digital pass deployable by the one or more network devices.

3. The digital pass system of claim 1 further comprising an artificial intelligence algorithm adapted to personalize promotional information sent to users.

4. The digital pass system of claim 1 further comprising at least one further user interface screen adapted to allow at least one or more of the at least one user and the at least one second user to sign up to receive credentials, log in to an associated dashboard, the dashboard designed to allow at least one or more of: create a new digital pass, edit a digital pass, configure a digital pass, design a digital pass, deploy a digital pass, distribute a digital pass, use digital pass features, send messages to digital pass holders, track and measure digital pass campaigns, apply a code to a digital pass, send a bill, and pay a bill.

5. The digital pass system of claim 1 further comprising at least one or more of a pass store wherein at least one or more of the at least one user and the at least one second user can find, present, and transact digital passes, an ad network wherein the at least one user and the at least one second user are presented with localized advertising, and a pass marketplace wherein the at least one user and the at least one second user may find, present, and incorporate features into the digital pass.

6. The digital pass system of claim 1 further comprising a bidirectional capability wherein the at least one user and the at least one second user can respond to information sent and an associated call to action.

7. The digital pass system of claim 1 further comprising at least one identifier for each the at least one user and the at least one second user from which the digital pass system is adapted to collect data, the at least one identifier set apart from user-provided identity information.

8. A digital pass method comprising:
determining iteratively for at least one promotion a sought promotional outcome within a promotional environment spanning within 10 to 3,280 feet from a center of the promotional environment;
monitoring with a network interface assembly of the promotional environment;
determining within the promotional environment presence and trajectory of at least one or more of at least one user and at least one second user within the promotional environment—the at least one user and at least one second user considered as members of a member set, the member set definable at selected points in time—by at least one or more of a global positioning system, a Bluetooth beacon assembly within 33 feet of member mobile computerized devices, and an NFC tag within 0-2 inches of member mobile devices;
mapping within the promotional environment location and movement of the at least one user and at least one second user;
assessing iteratively available data from the at least one user and the at least one second user at given points in time and creating user data for each of the at least one user and the at least one second user, including for each user vector at least one or more of a spatial vector, a temporal vector, a material vector, and a risk vector;
comparing user data and vectors of the at least one user with user data and vectors of the at least one second user data and vectors, including the user data and vectors of at least one or more of past and present set members, and determining similarities and differences between the user data and vector of the at least one user and the at least one second user, and calculating at least one promotional score for the at least one user and calculating at least one promotional score for the at least one second user;
calculating from the at least one promotional score of the at least one user and the at least one promotional score of the at least one second user whether to send at least one promotion to at least one or more of the at least one user and the at least one second user;
predicting by way of at least one machine learning predictive algorithm, the at least one predictive algorithm at least one or more of decision trees and Bayesian networks, genetic programs, and nearest neighbor—the predictive algorithm receiving user data and vectors for at least one or more of past and present set members, the data and vectors based on at least one or more of the location of the at least one user, the time, the material associated with the information, and the probability the at least one user will respond to information positively, the probability further determined by at least one or more of past behavior statistics data and data the user has permitted the digital pass software to receive how many promotions to send and to which of at least one or more of at least one user and at least one second user, assigning at least one identifier for each member;
sending promotional passes to at least one or more of the at least one user and the at least one second user;
having at least one digital pass created through a digital pass portal by at least one or more of the at least one user or the at least one second user, the at least one digital pass created on at least one computerized device through at least one user interface upon receiving at least one promotion;
determining iteratively results of sending the at least one promotion to the at least one or more of the at least one user and the at least one second user of the user member and determining, iteratively, revised sought promotional outcomes within the promotional environment; and
continuing as iterative loops of the digital pass method wherein present set members may change through each iteration as the at least one user and the at least one second user move into and out of the promotional environment, iterative loops continuing until the at least one promotion ends.

9. The digital pass method of claim 8, the method further comprising at least one or more of the at least one user and the at least one second user selecting via at least one interface screen from at least one digital pass type, choosing from at least one action for the digital pass, configuring the digital pass, and activating the at least one digital pass, the at least one digital pass deployable by one or more network devices.

10. The digital pass method of claim 8, the method further comprising at least one or more of the at least one user and the at least one second user selecting from an at least one further user interface screen signing up to receive credentials, logging in to an associated dashboard, the dashboard allowing at least one or more of creating a new digital pass, editing a digital pass, configuring a digital pass, deploying a digital pass, distributing a digital pass, using digital pass features, sending messages to digital pass holders, tracking and measuring digital pass campaigns, applying a code to a digital pass, sending a bill, and paying a bill.

11. The digital pass method of claim 8 further comprising at least one or more of finding, presenting, and transacting at least one digital pass, presenting an ad network localized advertising, and finding, presenting, and incorporating features from a pass marketplace.

12. The digital pass method of claim 8, the method further comprising responding to information sent and associated calls to action via a bidirectional capability.

13. The digital pass method of claim 8, the method further comprising using at least one identifier for the at least one user from which the digital pass system collects data, the at least one identifier set apart from user-provided identity information.

14. A digital pass system comprising:
a network interface assembly having one or more network devices and adapted for at least one promotion to iteratively determine presence and trajectory of at least one user and at least one second user within a promotional environment;
a control circuit assembly adapted to receive and transmit information via the network interface assembly;
the promotional environment spanning within 10 to 3,280 feet from a center of the promotional environment, the at least one user and the at least one second user considered members within a member set, the member set definable at selected points in time and monitorable by member therein with a global positioning system and a Bluetooth beacon assembly within 33 feet of given members, the at least one user and the at least one second user detectable from an at least one computerized device;
the network interface assembly adapted to map within the promotional environment location and movement of the at least one user and the at least one second user;
the network interface adapted to communicate with the at least one user and the at least one second user, allowing the at least one user and the at least one second user to initiate the communication from at least one computerized device, the network interface adapted to allow the at least one user and the at least one second user to retain as undisclosed personal identity information;
at least one user interface wherein the at least one user and the at least one second user may create through a digital pass portal at least one digital pass on the at least one computerized device, the at least one computerized device adapted to accept receipt of information, coupons, and transactions via the network interface assembly, the user interface disposed on the at least one computerized device adapted to receive a user component of the digital pass system by at least one or more of scanning and tapping an optical code, a computer link, text, email, and an NFC tag;
wherein the digital pass system is adapted to selectively provide at least one or more of the at least one user and the at least one second user a promotion from which to create the at least one digital pass based on a promotional score of at least one user and the at least one second user calculated from user data and vectors for each of the at least one user and the at least one second user, the user data and vectors including at least one or more of a spatial vector, a temporal vector, a material vector, and a risk vector, the promotional score adapted to indicate a probability the at least one user and the at least one second user will act to create and use at least one digital pass; and
the network interface assembly adapted to assign an identity to each of the at least one user and the at least one second user, the identity adapted to be apart from personal identity as a serial number, the network interface assembly further adapted to iteratively receive data that is at least one or more of tracked from the at least one user and the at least one second user and permitted by the at least one user and the at least one second user, the data which contributes to the user vector of each of the at least one user and the at least one second user wherein user vectors of the set members are compared with user data and vectors for at least one or more of past and present set members when determining promotional scores, wherein similarities and differences between user vectors data for past and present set members are adapted to be used, by way of at least one machine learning predictive algorithm including at least one or more of decision trees and Bayesian networks to predict whether the at least one user is a better candidate for receiving a promotion than the at least one second user, the data and vectors based on at least one or more of the location of the at least one user, the time, the material associated with the information, and the probability the at least one user will respond to information positively, the probability further determined by at least one or more of past behavior statistics data and data the user has permitted the digital pass software to receive, assigning at least one identifier for each given member.

15. The digital pass system of claim 14 further comprising at least one or more of a pass store wherein selected users and second users can find, present, and transact digital passes, an ad network wherein the selected users and second users are presented with localized advertising, and a pass marketplace wherein the selected users and second users may find, present, and incorporate features into their digital passes.

16. The digital pass system of claim 14, wherein the selected users and second users interface with at least one QR code.

17. The digital pass system of claim 14, wherein there is at least one identifier for the at least one user and the at least one second user from which the digital pass system is adapted to collect data, the at least one identifier set apart from user-provided identity information.
